(19) United States
(12) Patent Application Publication
(10) Pub. No.: US 2009/0081377 A1
(43) Pub. Date: Mar. 26, 2009

(54) FILM-FORMING COMPOSITION AND PRODUCTION METHOD OF FILM

(75) Inventor: Yohei KUBO, Shizuoka (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/237,453

(22) Filed: Sep. 25, 2008

(30) Foreign Application Priority Data
Sep. 26, 2007 (JP) 2007-249787

(51) Int. Cl. C08F 2/54; C08K 5/41; C08K 5/36; C08F 2/46; C08L 49/00

(52) U.S. Cl. 427/496; 524/392; 524/550

(57) ABSTRACT

A film-forming composition, includes: a photoacid generator; and a crosslinked or crosslinkable polyphenylene that is a product of a Diels-Alder reaction between at least one kind of a compound having two or more diene functional groups and at least one kind of a compound having two or more dienophile functional groups, in which at least one of the compounds has three functional groups as the functional group, and a method for producing a film, includes: applying the film-forming composition to a substrate; and irradiating the applied composition with an electron beam or an electromagnetic wave at a wavelength larger than 200 nm.

### BACKGROUND OF THE INVENTION

1. Field of the Invention

The present invention relates to a film-forming composition and a production method of a film. More specifically, the present invention relates to a film-forming composition for forming an insulating film in microelectronics, which uses a polyphenylene oligomer or polymer as a dielectric resin.

2. Description of the Related Art

A polymer dielectric is used as an insulating layer between various circuits as well as between layers within the circuit in a microelectronic device such as integrated circuit, multichip module and laminated circuit board. The microelectronics industry is moving toward smaller geometry in its device to enable lower power and faster speed. The conductor line becomes finer and more closely packed and therefore, the requirement of the dielectric between such conductors becomes more stringent.

The polymer dielectric often provides a lower dielectric constant than an inorganic dielectric such as silicon dioxide, and it is being attempted to process integration during fabrication. For example, silicon dioxide is used as a dielectric in an integrated circuit and to compete with this, the polymer dielectric must be able to withstand the processing temperature during vapor deposition and annealing steps. Preferably, the dielectric material should have a glass transition temperature higher than the processing temperature. The dielectric must also retain the desirable properties under device use conditions. For example, the dielectric should not absorb water which may cause corrosion of a metal conductor and may lead to an increase in the dielectric constant.

For some integration techniques, the oligomer should preferably planarize and gap fill a patterned surface when applied by a conventional method such as spin coating.

At present, a polyimide resin is used as a kind of thin-film dielectric material in the electronics industry. However, the polyimide resin may absorb water and hydrolyze, which possibly leads to circuit corrosion. A metal ion may migrate into the dielectric polyimide layer requiring a barrier layer between the metal line and the polyimide dielectric. The polyimide is poor in the planarization and gap fill properties. A non-fluorinated polyimide exhibits an undesirably high dielectric constant.

Many polyphenylenes produced from a biscyclo-pentadienone and a bisacetylene are disclosed, and it is taught that the polyphenylene has potential as a photodefineable organic dielectric (Kumar and Neenan, Macromolecules, 28, pp. 124-130 (1995)).

Also, copolymerization of 1,4-bis(phenylethynyl)-benzene with 3,3′-(1,4-phenylene)-bis(2,4,5-triphenyl-pentadienone) is disclosed, and it is reported that a soluble, yellow and infusible polymer was obtained (Wrasidlo and Augl, J. Polym. Sci., Part B, 7(7), 519-523 (1969)).

The materials described in Kumar and Neenan, Macromolecules, 28, pp. 124-130 (1995) and Wrasidlo and Augl, J. Polym. Sci., Part B, 7(7), 519-523 (1969) are soluble but not suitable for uses such as spin coating to fill gaps, because the materials are polymerized to exhaust the cyclopentadienone moiety and provide a relatively high molecular weight. The molecular weight may be too high to permit application by spin coating over a patterned surface containing gaps to be filled by the dielectric. Based on the reported glass transition temperature, such a material may not be able to withstand the processing desired for an integrated dielectric layer in an integrated circuit.

Tour describes many production methods of a cross-linkable polyphenylene composition for the preparation of glassy carbon (U.S. Pat. No. 5,334,668, U.S. Pat. No. 5,236,686, U.S. Pat. No. 5,169,929 and U.S. Pat. No. 5,338,823). The polyphenylene is produced by polymerizing 1-bromo-4-lithiobenzene to form a brominated polyphenylene and then coupling a substituted phenylacetylene such as phenylacetylenyl phenyl acetylene to the residual bromine. This polyphenylene has a melting point of nearly 200° C. before crosslinking.

### SUMMARY OF THE INVENTION

An object of the present invention is to provide a composition for solving the problems described above. That is, an object of the present invention is to provide a film-forming composition capable of forming a good interlayer insulating film by using a polymer dielectric which gives a reliably low dielectric constant, high thermal stability, high mechanical strength and a high glass transition temperature and which permits application preferably by spin coating to planarize and gap fill a patterned surface; and a production method of a film. (The term “insulating film” is also referred to as “dielectric film” and “dielectric insulating film”, but these terms are not substantially distinguished.)

As a result of intensive studies, the present inventors have found the above-described object can be attained by the following means.

(1) A film-forming composition, comprising:

a photoacid generator; and

a crosslinked or crosslinkable polyphenylene that is a product of a Diels-Alder reaction between at least one kind of a compound having two or more diene functional groups and at least one kind of a compound having two or more dienophile functional groups, in which at least one of the compounds has three functional groups as the functional group.

(2) The film-forming composition as described in (1) above,

wherein the dienophile functional group is an acetylene group.

(3) The film-forming composition as described in (2) above,

wherein the polyphenylene is an oligomer, an uncured polymer or a cured polymer,

the diene functional group is a cyclopentadienone group, and

a ratio of cyclopentadienone group: acetylene group is from 1:1 to 1:3.

(4) The film-forming composition as described in any of (1) to (3) above, further comprising:

an adhesion promoter.

(5) The film-forming composition as described in any of (1) to (4) above,

wherein the polyphenylene is an oligomer, an uncured polymer or a cured polymer, which is produced by reacting a biscyclopentadienone (a) represented by the following formula and an aromatic acetylene (b) containing three or more acetylene groups represented by the following formula:

(a) biscyclopentadienone

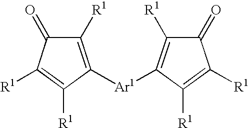

(b) polyfunctional acetylene

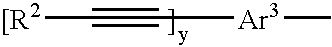

wherein R¹ and R² each independently represents H or an unsubstituted or inertly-substituted aromatic moiety;

Ar¹ and Ar³ each independently represents an unsubstituted aromatic moiety or inertly-substituted aromatic moiety; and

y represents an integer of 3 or more.

(6) The film-forming composition as described in any of (1) to (5) above,

wherein the photoacid generator generates an acid upon irradiation with an electron beam or an electromagnetic wave at a wavelength larger than 200 nm.

(7) The film-forming composition as described in (6) above,

wherein the photoacid generator is a compound represented by any one of formulae (ZI), (ZII) and (ZIII):

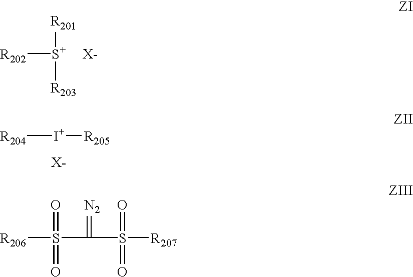

wherein,

in formula (ZI), R₂₀₁, R₂₀₂ and R₂₀₃ each independently represents an organic group; and X⁻ represents a non-nucleophilic anion, and

in formulae (ZII) and (ZIII), R₂₀₄ to R₂₀₇ each independently represents an aryl group which may have a substituent or an alkyl group which may have a substituent; and X⁻ represents a non-nucleophilic anion.

(8) A method for producing a film, comprising:

applying the film-forming composition of any of (1) to (7) above to a substrate; and

irradiating the applied composition with an electron beam or an electromagnetic wave at a wavelength larger than 200 nm.

### DETAILED DESCRIPTION OF THE INVENTION

The present invention is described in detail below.

In a first aspect, the present invention is a film-forming composition comprising a photoacid generator and an oligomer, uncured polymer or cured polymer containing a reaction product of one or more polyfunctional compounds containing two or more cyclopentadienone groups with at least one polyfunctional compound containing two or more aromatic acetylene groups, where at least a part of the polyfunctional compounds contains three or more reactive groups.

Here, the reactive group means a cyclopentadienone or acetylene group. The oligomer means a reaction product of two or more monomer units for use in the present invention, which gap fills, that is, fills an irregular groove having a depth of 1 micron and a width of 1.5 micron without leaving a void when cured. The uncured polymer means a reaction product of monomers for use in the present invention, which no longer gap fills but contains a sufficient amount of an unreacted cyclopentadienone or acetylene functional group. The cured polymer means a reaction product of monomers for use in the present invention, which does not contain a significant amount of an unreacted cyclopentadiene or acetylene functional group. The sufficient amount of an unreacted cyclopentadienone or acetylene functional group requires that this moiety is reacted to further advance the polymerization. The photoacid generator means a photosensitizing agent having a function of generating an acid upon irradiation with an electron beam or an electromagnetic wave at a wavelength larger than 200 nm.

The present invention is characterized by containing a reaction product of one or more polyfunctional compounds containing two or more cyclopentadienone groups with at least one polyfunctional compound containing two or more aromatic acetylene groups, where at least a part of the polyfunctional compounds contains three or more reactive groups, and further by adding a photoacid generator. This is advantageous in that the reaction product gap fills and planarizes the patterned surface and when cured under the catalytic action of an acid produced from the photoacid generator, comes to have high thermal stability, a high glass transition point, high mechanical strength and a low dielectric constant.

In a second preferred aspect, the present invention is a film-forming composition containing a photoacid generator and an oligomer, uncured polymer or cured polymer comprising a reaction product of one or more polyfunctional compounds containing two or more cyclopentadienone groups with one or more polyfunctional compounds containing two or more aromatic acetylene groups, where at least a part of the polyfunctional compounds containing aromatic acetylene groups contains three or more acetylene groups.

The second aspect of the present invention is characterized by comprising a reaction product of one or more polyfunctional compounds containing two or more cyclopentadienone groups with at least one polyfunctional compound containing two or more aromatic acetylene groups, where at least a part of the polyfunctional compound containing aromatic acetylene groups contains three or more acetylene groups. This reaction product is advantageous in that it gap fills and planarizes the patterned plane and when cured under the catalytic action of an acid produced from the photoacid generator, comes to have high thermal stability, a high glass transition point, high mechanical strength and a low dielectric constant.

High thermal stability, a high glass transition temperature, high mechanical strength, a low dielectric constant and the ability to gap fill and planarize the patterned surface enable the composition of the present invention to be suitable as a polymer dielectric in the microelectronics industry. In particular, the combination of low dielectric constant, high thermal stability, high mechanical strength and high glass transition temperature allows the composition of the present invention to be used as an integrated dielectric layer in an integrated circuit.

The oligomer and polymer for use in the present invention and the corresponding starting monomers are preferably as follows.

### I. Oligomer and Polymer of the Following Formula

[A]_{w}[B]_{z}[EG]ᵥ

wherein A has a structure represented by the following formula:

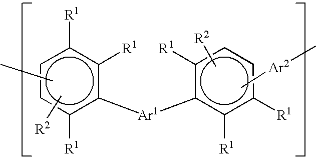

B has a structure represented by the following formula:

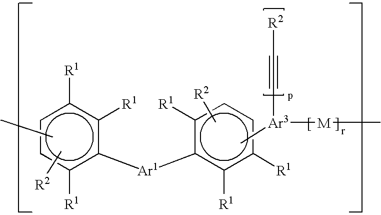

and EG is a terminal group having one or more structures represented by the following formula:

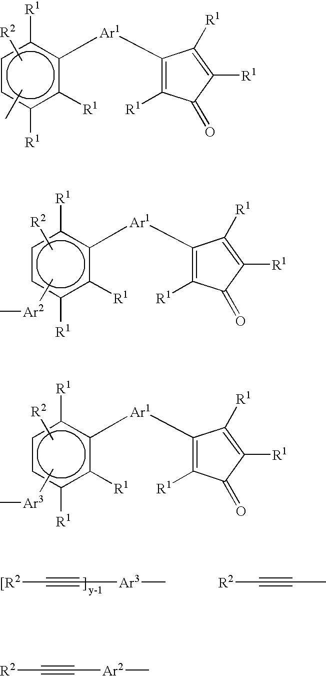

wherein R¹ and R² each is independently H or an unsubstituted or inertly-substituted aromatic moiety, Ar¹, Ar² and Ar³ each is independently an unsubstituted aromatic moiety or inertly-substituted aromatic moiety, M is a bond, y is an integer of 3 or more, p is the number of unreacted acetylene groups in the monomer unit, r is the number smaller by 1 than the number of reacted acetylene groups in the monomer unit, p+r=y−1, z is an integer of 0 to 1,000, w is an integer of 0 to 1,000, and v is an integer of 2 or more.

These oligomer and polymer each is produced by reacting a biscyclopentadienone, an aromatic acetylene containing three or more acetylene groups and, if desired, a polyfunctional compound containing two aromatic acetylene moieties. This reaction is represented by the reaction of compounds of the following formulae:

(a) a biscyclopentadienone of the following formula:

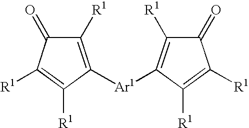

(b) a polyfunctional acetylene of the following formula:

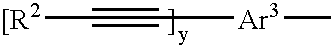

and, if desired, (c) a diacetylene of the following formula:

R²≡Ar²≡R²

(wherein R¹, R², Ar¹, Ar², Ar³ and y are the same as defined above).

The definition of the aromatic moiety includes phenyl, polyaromatic and fused aromatic moieties. The “inertly-substituted” means that the substituent is substantially inert to the polymerization reaction of cyclopentadienone and acetylene and does not readily react with an environmental substance such as water under the conditions of use of the cured polymer in a microelectronic device. Examples of such a substituent include F, Cl, Br, —CF₃, —OCH₃, —OCF₃, —O—Ph, an alkyl having a carbon number of 1 to 8, and a cycloalkyl having a carbon number of 3 to 8. For example, the unsubstituted or inertly-substituted aromatic moiety includes the followings.

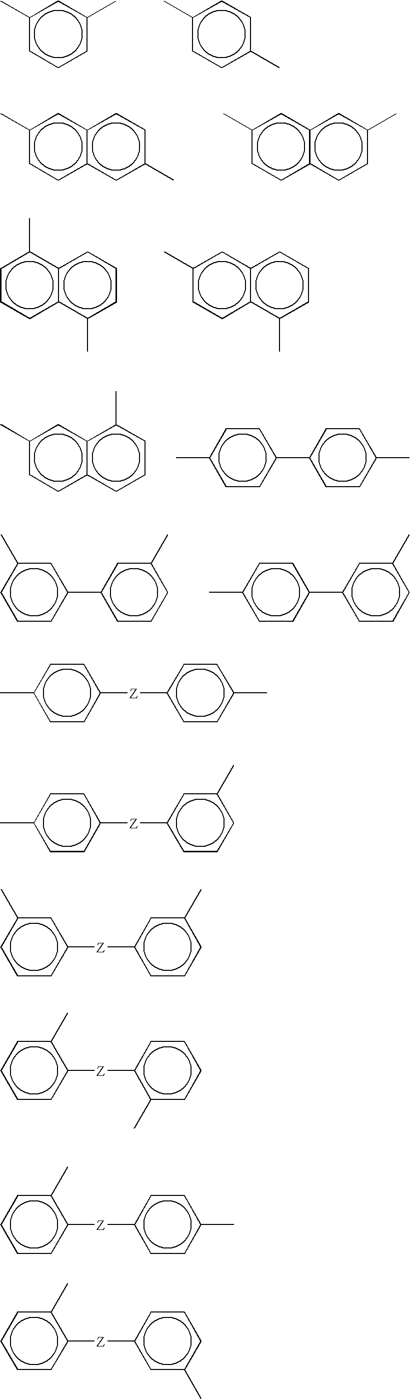

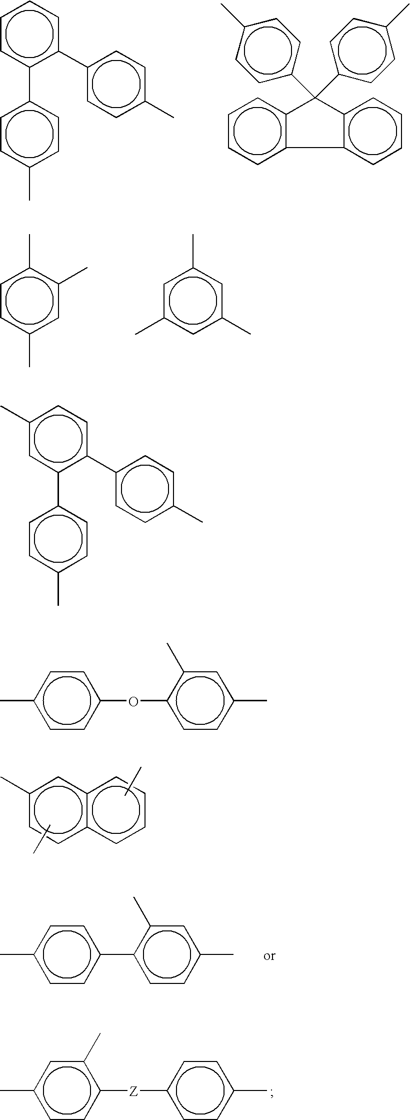

In the formulae, Z may be —O—, —S—, an alkylene, —CF₂—, —CH₂—, —O—CF₂—, a perfluoroalkyl, a perfluoroalkoxy,

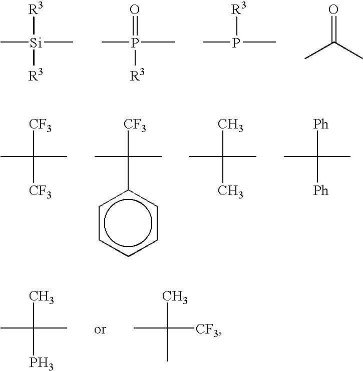

wherein each R³ is independently H, —CH₃, —CH₂CH₃, —(CH₂)₂CH₃ or Ph. Ph is phenyl.

### II. Polyphenylene Oligomer and Polymer of the Following Formulae

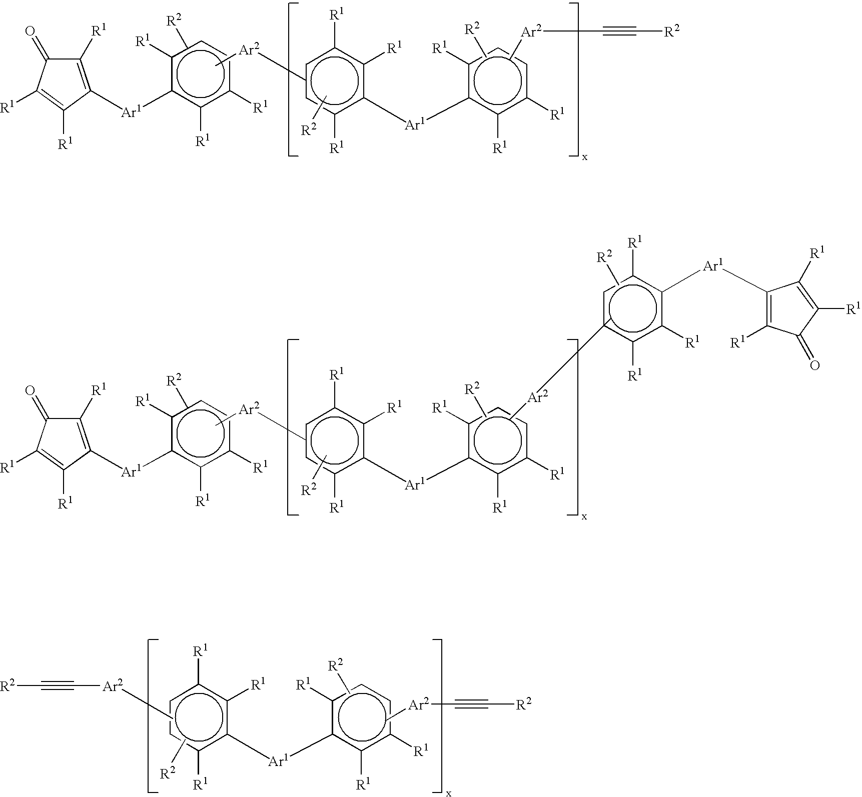

wherein R¹, R², Ar¹ and Ar² are the same as defined above, and x is an integer of 1 to 1,000. x is preferably an integer of 1 to 50, more preferably from 1 to 10.

These oligomer and polymer each is produced by the reaction of a biscyclopentadienone and a diacetylene of the following formulae:

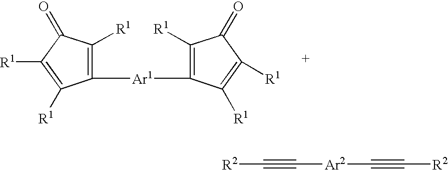

(wherein R¹, R², Ar¹ and Ar² are the same as defined above).

### III. Polyphenylene Oligomer and Polymer of the Following Formula:

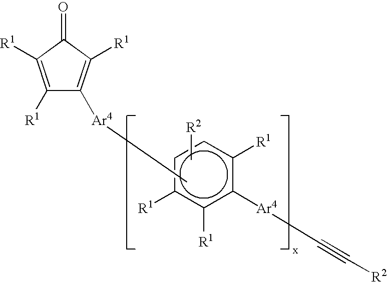

wherein Ar⁴ is an aromatic moiety or an inertly-substituted aromatic moiety, and R¹, R² and x are the same as defined above.

These oligomer and polymer each is produced by the reaction of the acetylene functional group and the cyclopentadienone functional group of a polyfunctional compound represented by the following formula:

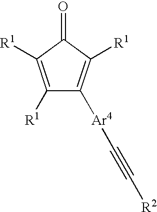

(wherein R¹, R² and Ar⁴ are the same as defined above).

### IV. Polyphenylene Oligomer and Polymer of the Following Formula:

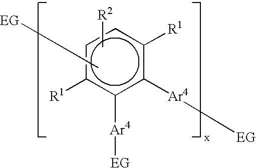

wherein EG is represented by any one of the following formulae:

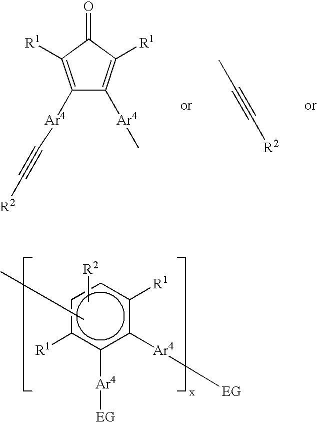

(wherein R¹, R², Ar⁴ and x are the same as defined above).

These oligomer and polymer each is produced by the reaction of the acetylene functional group and the cyclopentadienone functional group of a polyfunctional compound represented by the following formula:

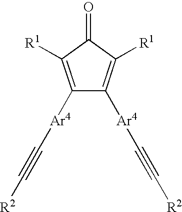

(wherein R¹, R² and Ar⁴ are the same as defined above).

The polyfunctional compound containing two or more aromatic cyclopentadienone moieties is produced through the condensation of a benzil and a benzyl ketone by using a conventional method. Examples of the method are described in Kumar et al. Macromolecules, 1995, 28, 124-130, Ogliaruso et al., J. Org. Chem., 1965, 30, 3354, Ogliaruso et al., J. Org. Chem., 1963, 28, 2725, and U.S. Pat. No. 4,400,540.

The polyfunctional compound containing two or more aromatic acetylene moieties is produced by a conventional method. An aromatic compound is halogenated and then reacted with an appropriate substituted acetylene in the presence of an aryl ethynylation catalyst to replace the halogen with a substituted acetylene compound.

The polyfunctional compound produced is preferably purified. Particularly, in use as an organic polymer dielectric, metals and ionic substances are removed. For example, the polyfunctional compound containing aromatic acetylene groups is contacted with washing water and an aliphatic hydrocarbon solvent and then dissolved in an aromatic solvent, and the solution is filtered through a pure silica gel. By this treatment, the residual ethynylation catalyst is removed. Additional recrystallization also promotes the removal of undesired impurities.

While not being bound by theory, it is considered that the polyphenylene oligomer and polymer are formed through a Diels-Alder reaction between a cyclopentadienone group and an acetylene group when a mixture of cyclopentadienone and acetylene is heated in a solution. This oligomer may contain cyclopentadienone and/or acetylene terminal groups and/or side groups. When this solution or a product coated with the solution is further UV-cured, chain extension additionally occurs due to a Diels-Alder reaction of the remaining cyclopentadienone terminal group with the remaining acetylene group and the molecular weight increases. At this time, the acid generated from the photoacid generator upon UV irradiation is considered to more promote the Diels-Alder reaction. Also, depending on the temperature used, a reaction may occur between acetylene groups with each other.

These oligomer and polymer are known in view of the structure to have any one of cyclopentadienone and/or acetylene terminal groups and/or side groups. The terminal group is usually determined by the relative concentration of cyclopentadienone to the Diels-Alder reactive acetylene functional group used in the reaction, and a stoichiometric excess of a cyclopentadienone functional group gives a greater proportion of a cyclopentadienone terminal group, whereas a stoichiometric excess of a Diels-Alder reactive acetylene functional group gives a greater proportion of an acetylene terminal group.

A preferred embodiment of the present invention is characterized in that the polymerization reaction is halted before all cyclopentadienone moieties are reacted. Prior to advancing the polymerization and allowing the remaining cyclopentadienone moieties to react, the oligomer is applied to a surface. In such an oligomerized state, the oligomer planarizes and gap fills when applied to a patterned surface. At least 10% of the cyclopentadienone moiety is preferably unreacted. Most preferably, at least 12% of the cyclopentadienone moiety is unreacted. The percentage of the unreacted cyclopentadienone moiety may be determined by spectrometry. The cyclopentadienone moiety is fairly colored in the visible spectrum and appears distinctly red or purple and when the cyclopentadienone moiety is reacted, this color fades.

The term “planarize” as used herein means that an isolated plane is planarized by 17% or more, preferably 18% or more, more preferably 19% or more. This planarization degree is calculated according to the following formula:

Percentage of planarization=(1−tₛ/tₘ)×100

In the case where a layer of the oligomer is applied on a square line of 1 μm in width and 1 μm in height to an average thickness of 2 μm, tₛ is the height of the oligomer or polymer on the plane above the average height of the oligomer or polymer and tₘ is the height of the plane (1 μm). Use of this definition is described, for example, in Proceedings of IEEE, Vol. 80, No. 12, page 1948 (December, 1992).

While not being bound by theory, the production of the polyphenylene polymer is represented by the following formulae:

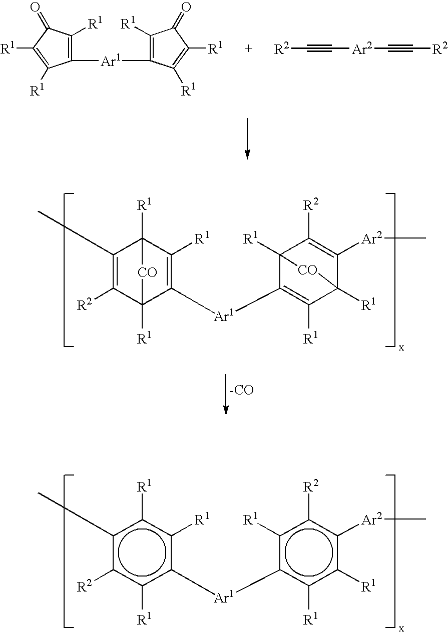

wherein R¹, R², Ar¹, Ar² and x are the same as defined above.

Furthermore, although not specifically indicated in the structures, a carbonyl-bridged substance is present in the oligomer produced, depending on monomers and reaction conditions used. On further heating, the carbonyl-bridged substances all are essentially converted into an aromatic ring. When one or more acetylene-containing monomers are used, the oligomer and polymer formed are random, though the structure indicated suggests the formation of a block. A Diels-Alder reaction between the cyclopentadienone and acetylene functional groups takes place to form a para- or meta-bond on the phenylated ring.

An inert organic solvent which can dissolve the monomers to an appropriate degree and can be heated to an appropriate polymerization temperature under atmospheric pressure, reduced pressure or overpressure may be used. Suitable examples of the solvent include mesitylene, pyridine, triethylamine, N-methylpyrrolidinone (NMP), methyl benzoate, ethyl benzoate, butyl benzoate, cyclopentanone, cyclohexanone, cycloheptanone, cyclooctanone, cyclohexylpyrrolidinone, and an ether or hydroxy ether such as dibenzyl ether, diglyme, triglyme, diethylene glycol ethyl ether, diethylene glycol methyl ether, dipropylene glycol methyl ether, dipropylene glycol dimethyl ether, propylene glycol phenyl ether, propylene glycol methyl ether, tripropylene glycol methyl ether, toluene, mesitylene, xylene, benzene, dipropylene glycol monomethyl ether acetate, dichlorobenzene, propylene carbonate, naphthalene, diphenyl ether, butyrolactone, dimethylacetamide, dimethylformamide, and a mixture thereof. Among these solvent, preferred are mesitylene, N-methyl-pyrrolidinone (NMP), γ-butyrolactone, diphenyl ether, and a mixture thereof.

Also, the monomers may be reacted in one or more solvents at a high temperature, and the resulting oligomer solution may be cooled and mixed with one or more other solvents, for example, to promote the processing. In another method, the monomers may be reacted in one or more solvents at a high temperature to form an oligomer and the oligomer may be then isolated by precipitation in a non-solvent or by other means of solvent removal to give an essentially solvent-free oligomer. This isolated oligomer may be further redissolved in one or more different solvents, and the resultant solution may be used for processing.

The conditions under which the polymerization reaction is most advantageously performed vary depending on various factors including the reactant and solvent. In general, the reaction is performed in a non-oxidizing atmosphere, such as in nitrogen or other inert gases. The reaction may be performed as it is (without using a solvent or other diluents). However, in order to ensure a homogeneous reaction mixture and moderate heat generation at the temperature in the system, it is preferred to use an inert organic solvent such as those described above.

The time and temperature most advantageously employed greatly vary depending on the monomers used, particularly their reactivity, the desired oligomer or polymer, and the solvent. In general, the reaction for forming the oligomer is performed at a temperature of 150 to 250° C. for from 60 minutes to 48 hours. At this point, the oligomer may be isolated from the reaction mixture or may be used as it is in the coating of a surface.

In the present invention, at the time of irradiating an electron beam or an electromagnetic wave at a wavelength larger than 200 nm, a heat treatment is preferably performed. In this case, the heating temperature is preferably from 300 to 450° C., more preferably from 300 to 420° C., still more preferably from 350 to 400° C., and the heating time is preferably from 1 minute to 1 hour, more preferably from 1 to 45 minutes, still more preferably from 1 to 30 minutes. The heat treatment may be performed in several steps.

In the present invention, in the case of irradiating an electron beam, the energy of the electron beam is preferably such that the energy implanted into the film preferably accounts for 5% or more, more preferably 20% or more, and most preferably 50% or more, based on the number of electrons implanted.

In the present invention, in the case of irradiating an electron beam, if the irradiation dose of electron beam per unit time is excessively large, the film is damaged. Therefore, the irradiation dose of electron beam is preferably 1 mA/cm² or less, more preferably 500 μA/cm² or less, and most preferably 300 μA/cm² or less.

In the present invention, in the case of irradiating an electromagnetic wave at a wavelength larger than 200 nm, the energy of the electromagnetic wave is, in terms of the wavelength, preferably larger than 200 nm and smaller than 600 nm. However, the wavelength of the electromagnetic waver for use in the present invention can be selected from the electromagnetic wave absorption spectrum of the film-forming composition. For example, when a material sensitive to visible light, such as camphorquinone, or a functional group sensitive to visible light is used in the composition, an electromagnetic wave in the visible region may be selected.

The concentration at which the monomer is most advantageously used in the organic liquid reaction medium varies depending on various factors including the monomer and organic liquid used and the oligomer and polymer intended to produce. In general, the monomers are used to give a cyclopentadienone:acetylene stoichiometric ratio of from 1:1 to 1:3, preferably from 1:1 to 1:2.

The oligomer or polymer may be directly cast as a film and applied as a coating or may be poured into a non-solvent to precipitate the oligomer or polymer. Water, methanol, ethanol and other similar polar liquids are typical examples of the non-solvent which can be used to precipitate the oligomer. A solid oligomer or polymer may be dissolved and processed from a suitable solvent. In the case where the oligomer or polymer is obtained in a solid form, the oligomer or polymer may be further processed using a conventional compression molding method or a melt spinning, casting or extrusion method, where, however, the solid precursor must have a sufficiently low glass transition temperature.

More commonly, the oligomer or polymer is processed directly from the organic liquid reaction solution and in this case, the advantages of the present invention are perfectly realized. The oligomer or polymer is soluble in the organic liquid reaction medium and therefore, it is possible to cast or apply the organic solution of the oligomer and then remove the solvent. Upon subsequent exposure to a high temperature, the molecular weight increases (chain extension or advancement) and in some cases, crosslinking occurs to form a final polymer.

The polymer of the present invention can be used as one or more insulating or dielectric layers in a single-layer or multilayer electrical connection structure for integrated circuits, multichip modules or flat panel displays. The polymer of the present invention may be used as a sole dielectric in these uses or may be used together with another organic polymer or an inorganic dielectric such as silicon dioxide, silicon nitride or silicon oxynitride.

For example, a coating of the oligomer or polymer of the present invention, such as insulating coating used to fabricate a connection structure on a wafer, is easily produced by spin-casting a film of, or otherwise coating a substrate with, the organic liquid solution of the oligomer or polymer, then evaporating the solvent, and exposing the oligomer or polymer to a temperature high enough to advance the oligomer or polymer into a higher molecular weight, thereby forming most preferably a crosslinked polymer having a high glass transition temperature.

The polymer of the present invention is particularly effective as a low dielectric constant insulating material in the connection structure of an integrated circuit, such as those fabricated with gallium arsenide or silicon. An integrated circuit usually has many layers of metal conductors separated by one or more insulating materials. The polymer material of the present invention can be used as an insulating material between discrete metal conductors in the same layer and/or between electrical conductors of the connection structure. The polymer of the present invention can also be used together with other materials, such as SiO₂ or Si₃N₄, in a composite connection structure. For example, the oligomer and polymer of the present invention may be used in the production method of an integrated circuit device taught in U.S. Pat. Nos. 5,550,405 and 5,591,677 and Hayashi et al., 1996 Symposium on VLSI Technology Digest of Technical Papers, pp. 88-89. The oligomer and polymer of the invention may be substituted for the BCB or other resins.

The oligomer, uncured polymer or cured polymer of the present invention may be used as a dielectric in the method of fabricating an integrated circuit comprising an active substrate containing a transistor and an electrical connection structure that contains patterned metal lines separated, at least partially, by a layer of the composition of the present invention.

The polymer of the present invention is also effective for planarization of a material such as silicon wafer used in a semiconductor to allow for production of smaller (higher density) circuitry. To achieve the desired planarity, a coating of the oligomer or polymer is applied from a solution, for example, by spin coating or spray coating, thereby leveling the roughness on the substrate surface. This method is described in publications such as Jenekhe, S A., Polymer Processing to Thin Films for Microelectronic Applications in Polymers for High Technology, and Bowden et al., American Chemical Society 1987, pp. 261-269.

In the fabrication of a microelectronic device, a relatively thin defect-free film of generally from 0.01 to 20 μm, preferably from 0.1 to 2 μm, in thickness is deposited on the surface of a substrate such as silicon, silicon-containing material, silicon dioxide, alumina, copper, silicon nitride, aluminum nitride, aluminum, quartz and gallium arsenide. A coating is usually formed from a solution of an oligomer having a molecular weight, for example, of 3,000 Mₙ or less and 5,200 M_{w} or less in various organic solvents such as xylene, mesitylene, NMP, γ-butyrolactone and n-butyl acetate. The dissolved oligomer or polymer is cast on a substrate by a normal spin or spray coating method. The thickness of the coating can be controlled by varying the solid content percentage or molecular weight, that is, viscosity, of the solution or by varying the spin speed.

The polyphenylene oligomer or polymer in the present invention may be applied by dip coating, spray coating, extrusion coating, or more preferably spin coating. For all cases, the environment around the substrate and coating before curing is controlled with respect to the temperature and humidity. In particular, NMP absorbs water from the water vapor in the ambient air. When dissolved in NMP, the solution must be protected from moist air and the film must cast in a low humidity environment. In the case of using NMP as the solvent, preferably, the relative humidity is controlled to less than 30% and the temperature is controlled to 27° C. or more. The coating applied may be then cured using one or more hot plates, an oven, or a combination thereof.

An adhesion promoter such as those based on silane may be applied to the substrate before coating the polyphenylene oligomer or polymer or may be added directly to the solution.

The oligomer and polymer of the present invention can be used in a “damascene” metal inlay or subtractive metal patterning method for the fabrication of an integrated circuit connection structure. The methods for fabricating damascene lines and vias are known in the art. See, for example, U.S. Pat. Nos. 5,262,354 and 5,093,279.

Patterning of the material may be performed through a reactive ion etching procedure by using oxygen, argon, helium, carbon dioxide, a fluorine-containing compound or a mixture of such a gas and other gases and using a photoresist “softmask”, such as an epoxy novolak, or a photoresist combined with an inorganic “hardmask” such as SiO₂, Si₃N₄ or metal.

The oligomer and polymer may be used together with Al, an Al alloy, Cu, a Cu alloy, gold, silver, W and other general metal conductor materials (for electrical conductive lines and plugs) that are deposited by physical vapor deposition, chemical vapor deposition, evaporation, electroplating or other deposition methods. A metal layer other than the base metal conductor, such as tantalum, titanium, tungsten, chromium, cobalt, an alloy thereof or a nitride thereof, may be used to fill holes, enhance adhesion, provide a barrier or improve metal reflectivity.

Depending on the fabrication method, the metal or the dielectric material of the present invention may be removed or planarized using a chemical-mechanical polishing method. A multichip module on an active or passive substrate such as silicon, silicate glass, silicon carbide, aluminum, aluminum nitride or FR-4 may be constructed with the polyphenylene polymer of the present invention as a dielectric material.

A flat panel display on an active or passive substrate such as silicon, silicate glass, silicon carbide, aluminum, aluminum nitride or FR-4 may be constructed with the polyphenylene polymer of the present invention as a dielectric material.

The oligomer and polymer of the present invention may also be used as a protective coating on an integrated circuit chip for the protection against an alpha particle. A semiconductor device is susceptible to a soft error when an alpha particle emitted from a radioactive trace contaminant in the packaging strikes the active surface. In general, an integrated circuit chip is mounted on a substrate and fixed with an appropriate adhesive. A coating of the polymer of the present invention provides an alpha particle protection layer to the active surface of the chip. If desired, additional protection may be provided by an encapsulant made of, for example, epoxy or silicone.

The polymer of the present invention may also be used as a substrate (dielectric material) in a circuit board or a printed wiring board. On the circuit board formed of the polymer of the present invention, a surface pattern for various electrical conductor circuits is provided. This circuit board may contain, in addition to the polymer of the present invention, various reinforcements such as woven non-conducting fiber (e.g., glass cloth). The circuit board may be single-sided, double-sided or multilayer.

The polymer of the present invention may also be effective in a reinforced composite in which a resin matrix polymer is reinforced with one or more reinforcing materials such as reinforcing fiber or mat. Examples of the reinforcing material include fiber glass, particularly fiber glass mat (woven or nonwoven); graphite, particularly graphite mat (woven or nonwoven); Kevlar (trademark); Nomex (trademark); and a glass sphere. This composite can be produced from a preform, a dipping mat in monomer or oligomer, and resin transfer molding (where the mat is placed in the mold and a monomer or prepolymer is added and heated to polymerize).

The layer of the polymer of the present invention is patterned by wet etching, plasma etching, reactive ion etching (RIE), dry etching or photo-laser ablation, such as those described in Polymers for Electronic Applications, Lai, pp. 42-47, CRC Press (1989). The patterning is performed by a multilevel method where a pattern is lithographically formed in a resist layer coated on a polymeric dielectric layer and then etched into the bottom layer. A particularly effective method comprises masking the portion of the oligomer or polymer, which should not to be removed, removing the unmasked portion of the oligomer or polymer, and then curing the remaining oligomer or polymer, for example, under heat.

Furthermore, the oligomer of the present invention may also be used for the production of a shaped article, a film, a fiber and a foam. In general, a method well known in the art for casting an oligomer or polymer from a solution may be used for the preparation of a product above.

In producing a shaped article of the polyphenylene oligomer or polymer, additives such as filler, pigment, carbon black, electrically conductive metal particle, abrasive and lubricating polymer may be used. The method of incorporating such an additive is not critical, and the additive is preferably added to the oligomer or polymer solution before producing the shaped article. The liquid composition containing the oligomer or polymer alone or also containing a filler may be applied by a normal method (doctoring, rolling, dipping, brushing, spraying, spin coating, extrusion coating or meniscus coating) to a number of different substrates. If the polyphenylene oligomer or polymer is produced in a solid form, the additive is added to the melt before the processing into a shaped article.

The oligomer and polymer of the present invention can be applied to various substrates by a number of methods such as solution deposition, liquid-phase epitaxy, screen printing, melt-spinning, dip coating, spinning, brushing (for example as a varnish), spray coating, powder coating, plasma deposition, dispersion spraying, solution casting, slurry spraying, dry powder spraying, fluidized bed method, welding, explosion method (including Wire Explosion Spraying Method and explosion bonding), press bonding with heat, plasma polymerization, dispersion in a dispersion medium with subsequent removal of the dispersion medium, pressure bonding, heat bonding with pressure, gaseous environment vulcanization, extruding molten polymer, hot-gas welding, baking, coating, and sintering. A single-layer or multilayer film may also be deposited on a substrate by using a Langmuir-Blodgett method at an air-water or other interface.

In the case of applying the oligomer or polymer of the present invention from a solution, the polymerization conditions and other processing parameters, which are most advantageously employed, vary depending on many factors, particularly the specific oligomer or polymer intended to deposit, the coating conditions, the quality and thickness of coating, and the end-use application, and the solvent is selected accordingly. Examples of the solvent which can be used are as described above.

The substrate which is coated with the oligomer or polymer of the present invention may be any material as long as it has sufficient integrity high enough to be coated with the monomer, oligomer or polymer. Examples of the substrate include wood, metal, ceramic, glass, other polymers, paper, paper board cloth, woven fabric, nonwoven mat, synthetic fiber, Kevlar (trademark), carbon fiber, gallium arsenide, silicon, and other inorganic substrates and oxides thereof. The substrate used is selected based on the desired application. Examples thereof include a glass fiber (woven, nonwoven or strand), a ceramic, a metal such as aluminum, magnesium, titanium, copper, chromium, gold, silver, tungsten, stainless steel, Hastalloy (trademark), carbon steel, other metal alloys and oxides thereof, and thermosetting and thermoplastic polymers such as epoxy resin, polyimide, perfluorocyclobutane polymer, benzocyclobutane polymer, polystyrene, polyamide, polycarbonate, polyarylene ether and polyester. The substrate may be the polymer of the present invention in the cured form.

The substrate may be of any shape, and the shape is determined by the end-use application. For example, the substrate may be in the form of a disk, a plate, a wire, a tube, a board, a sphere, a rod, a pipe, a cylinder, a brick, a fiber, a woven or nonwoven fabric, a yarn (including a commingled yarn), an ordered polymer, or a woven or nonwoven mat. In each case, the substrate may be hollow or solid. In the case of a hollow substrate, the polymer layer may be provided on either one or both of the inside and the outside of the substrate. The substrate may comprise a porous layer, such as graphite mat or fabric, glass mat or fabric, scrim and particulate material.

The photoacid generator for use in the present invention generates an acid upon irradiation with an electron beam or an electromagnetic wave at a wavelength larger than 200 nm.

The photoacid generator which can be used may be appropriately selected from a photoinitiator for photo-cationic polymerization, a photoinitiator for photoradical polymerization, a photo-decoloring agent for coloring matters, a photo-discoloring agent, a compound known to generate an acid upon irradiation with an electron beam or an electromagnetic wave at a wavelength larger than 200 nm, and a mixture thereof.

Examples thereof include a diazonium salt, a phosphonium salt, a sulfonium salt, an iodonium salt, imidosulfonate, oxime sulfonate, diazodisulfone, disulfone and o-nitrobenzyl sulfonate.

Also, a compound where a group or compound capable of generating an acid upon irradiation with an electron beam or an electromagnetic wave at a wavelength larger than 200 nm is introduced into the main or side chain of the polymer, for example, compounds described in U.S. Pat. No. 3,849,137, German Patent 3,914,407, JP-A-63-26653, JP-A-55-164824, JP-A-62-69263, JP-A-63-146038, JP-A-63-163452, JP-A-62-153853 and JP-A-63-146029, may be used.

Furthermore, compounds capable of generating an acid by the effect of light described, for example, in U.S. Pat. No. 3,779,778 and European Patent 126,712 may also be used.

Out of the compounds capable of decomposing upon irradiation with an electron beam or an electromagnetic wave at a wavelength larger than 200 nm to generate an acid, which may be used in combination, the compounds represented by the following formulae (ZI), (ZII) and (ZIII) are preferred.

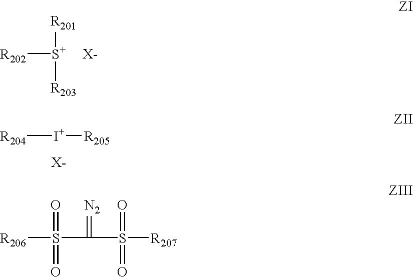

In formula (ZI), R₂₀₁, R₂₀₂ and R₂₀₃ each independently represents an organic group.

X⁻ represents a non-nucleophilic anion, and preferred examples thereof include sulfonate anion, carboxylate anion, bis(alkylsulfonyl)amide anion, tris(alkylsulfonyl)methide anion, BF₄⁻, PF₆⁻ and SbF₆⁻. The anion is preferably an organic anion containing a carbon atom.

The preferred organic anion includes organic anions represented by the following formulae AN1 to AN4:

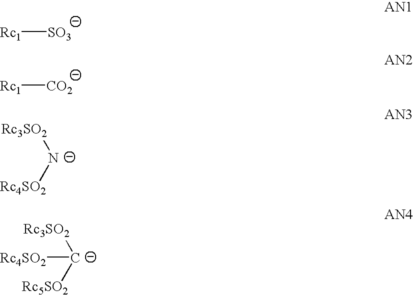

In the formulae, Rc₁ represents an organic group.

The organic group in Rc₁ includes an organic group preferably having a carbon number of 1 to 30 and is preferably an alkyl group which may be substituted, an aryl group which may be substituted, or a group where a plurality of such groups are connected through a single bond or a linking group such as —O—, —CO₂—, —S—, —SO₃— and —SO₂N (Rd₁)—.

Rd₁ represents a hydrogen atom or an alkyl group and may form a ring structure together with the alkyl or aryl group to which Rd₁ is bonded.

The organic group of Rc₁ is more preferably an alkyl group substituted by a fluorine atom or a fluoroalkyl group at the 1-position, or a phenyl group substituted by a fluorine atom or a fluoroalkyl group. By virtue of having a fluorine atom or a fluoroalkyl group, the acidity of the acid generated upon irradiation with light increases and the sensitivity is enhanced. When Rc₁ has 5 or more carbon atoms, at least one carbon atom is preferably substituted by a hydrogen atom, and it is more preferred that the number of hydrogen atoms is larger than the number of fluorine atoms. The absence of a perfluoroalkyl group having a carbon number of 5 or more enables reduction in the toxicity to ecology.

The most preferred embodiment of Rc₁ is a group represented by the following formula:

Rc₇—Ax—Rc₆—

Rc₆ represents a perfluoroalkylene group having a carbon number of 4 or less, preferably from 2 to 4, more preferably 2 or 3, or a phenylene group substituted by from 1 to 4 fluorine atoms and/or from 1 to 3 fluoroalkyl groups.

Ax represents a linking group (preferably a single bond, —O—, —CO₂—, —S—, —SO₃— or —SO₂N(Rd₁)—). Rd₁ represents a hydrogen atom or an alkyl group and may combine with Rc₇ to form a ring structure.

Rc₇ represents a hydrogen atom, a fluorine atom, a linear, branched, monocyclic or polycyclic alkyl group which may be substituted, or an aryl group which may be substituted. The alkyl group and aryl group, which may be substituted, each preferably contains no fluorine atom as the substituent.

Rc₃, Rc₄ and Rc₅ each represents an organic group. The preferred organic groups of Rc₃, Rc₄ and Rc₅ are the same as the preferred organic groups in Rc₁.

Rc₃ and Rc₄ may combine to form a ring.

The group formed by combining Rc₃ and Rc₄ includes an alkylene group and an arylene group and is preferably a perfluoroalkylene group having a carbon number of 2 to 4. When Rc₃ and Rc₄ combine to form a ring, the acidity of the acid generated upon irradiation with light increases and this is preferred because the sensitivity is enhanced.

The carbon number of the organic group as R₂₀₁, R₂₀₂ and R₂₀₃ is generally from 1 to 30, preferably from 1 to 20.

Two members but of R₂₀₁ to R₂₀₃ may combine to form a ring structure, and the ring may contain an oxygen atom, a sulfur atom, an ester bond, an amide bond or a carbonyl group.

Examples of the group formed by combining two members out of R₂₀₁ to R₂₀₃ include an alkylene group (e.g., butylene, pentylene).

Specific examples of the organic group as R₂₀₁, R₂₀₂ and R₂₀₃ include corresponding groups in the compounds (ZI-1), (ZI-2) and (ZI-3) which are described later.

The compound may be a compound having a plurality of structures represented by formula (ZI). For example, the compound may be a compound having a structure where at least one of R₂₀₁ to R₂₀₃ in the compound represented by formula (ZI) is bonded to at least one of R₂₀₁ to R₂₀₃ in another compound represented by formula (ZI).

The component (ZI) is more preferably a compound (ZI-1), (ZI-2) or (ZI-3) described below.

The compound (ZI-1) is an arylsulfonium compound where at least one of R₂₀₁ to R₂₀₃ in formula (Z1) is an aryl group, that is, a compound having an arylsulfonium as the cation.

In the arylsulfonium compound, R₂₀₁ to R₂₀₃ all may be an aryl group or a part of R₂₀₁ to R₂₀₃ may be an aryl group with the remaining being an alkyl group.

Examples of the arylsulfonium compound include a triarylsulfonium compound, a diarylalkylsulfonium compound, and an aryldialkylsulfonium compound.

The aryl group in the arylsulfonium compound is preferably an aryl group such as phenyl group and naphthyl group, or a heteroaryl group such as indole residue and pyrrole residue, more preferably a phenyl group or an indole residue. In the case where the arylsulfonium compound has two or more aryl groups, these two or more aryl groups may be the same or different.

The alkyl group which is present, if desired, in the arylsulfonium compound is preferably a linear, branched or cyclic alkyl group having a carbon number of 1 to 15, and examples thereof include a methyl group, an ethyl group, a propyl group, an n-butyl group, a sec-butyl group, a tert-butyl group, a cyclopropyl group, a cyclobutyl group, and a cyclohexyl group.

The aryl group and alkyl group of R₂₀₁ to R₂₀₃ each may have, as the substituent, an alkyl group (for example, an alkyl group having a carbon number of 1 to 15), an aryl group (for example, an aryl group having a carbon number of 6 to 14), an alkoxy group (for example, an alkoxy group having a carbon number of 1 to 15), a halogen atom, a hydroxyl group or a phenylthio group. The substituent is preferably a linear, branched or cyclic alkyl group having a carbon number of 1 to 12, or a linear, branched or cyclic alkoxy group having a carbon number of 1 to 12, and most preferably an alkyl group having a carbon number of 1 to 4, or an alkoxy group having a carbon number of 1 to 4. The substituent may be substituted to any one of three members R₂₀₁ to R₂₀₃ or may be substituted to all of these three members. In the case where R₂₀₁ to R₂₀₃ are an aryl group, the substituent is preferably substituted at the p-position of the aryl group.

The compound (ZI-2) is described below.

The compound (ZI-2) is a compound where R₂₀₁ to R₂₀₃ in formula (ZI) each independently represents an aromatic ring-free organic group. The aromatic ring as used herein includes an aromatic ring containing a heteroatom.

The aromatic ring-free organic group as R₂₀₁ to R₂₀₃ has a carbon number of generally 1 to 30, preferably from 1 to 20.

R₂₀₁ to R₂₀₃ each is independently preferably an alkyl group, a 2-oxoalkyl group, an alkoxycarbonylmethyl group, an allyl group or a vinyl group, more preferably a linear, branched or cyclic 2-oxoalkyl group or an alkoxycarbonyl-methyl group, and most preferably a linear or branched 2-oxoalkyl group.

The alkyl group as R₂₀₁ to R₂₀₃ may be linear, branched or cyclic and is preferably a linear or branched alkyl group having a carbon number of 1 to 10 (e.g., methyl, ethyl, propyl, butyl, pentyl) or a cyclic alkyl group having a carbon number of 3 to 10 (e.g., cyclopentyl, cyclohexyl, norbornyl).

The 2-oxoalkyl group as R₂₀₁ to R₂₀₃ may be linear, branched or cyclic and is preferably a group having >C═O at the 2-position of the above-described alkyl group.

The alkyl group in the alkoxycarbonylmethyl group as R₂₀₁ to R₂₀₃ is preferably an alkyl group having a carbon number of 1 to 5 (e.g., methyl, ethyl, propyl, butyl, pentyl).

R₂₀₁ to R₂₀₃ each may be further substituted by a halogen atom, an alkoxy group (for example, an alkoxy group having a carbon number of 1 to 5), a hydroxyl group, a cyano group or a nitro group.

Two members out of R₂₀₁ to R₂₀₃ may combine to form a ring structure, and the ring may contain an oxygen atom, a sulfur atom, an ester bond, an amide bond or a carbonyl group. Examples of the group formed by combining two members out of R₂₀₁ to R₂₀₃ include an alkylene group (e.g., butylene, pentylene).

The compound (ZI-3) is a compound represented by the following formula (ZI-3), and this is a compound having a phenacylsulfonium salt structure.

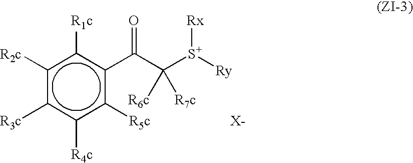

R_{1c} to R_{5c} each independently represents a hydrogen atom, an alkyl group, an alkoxy group or a halogen atom.

R_{6c} and R_{7c} each represents a hydrogen atom or an alkyl group.

Rₓ and R_{y} each independently represents an alkyl group, a 2-oxoalkyl group, an alkoxycarbonylmethyl group, an allyl group or a vinyl group.

Any two or more members out of R_{1c} to R_{5c} or a pair of Rₓ and R_{y} may combine with each other to form a ring structure, and the ring structure may contain an oxygen atom, a sulfur atom, an ester bond or an amide bond.

The alkyl group as R_{1c} to R_{5c} may be linear, branched or cyclic and is, for example, an alkyl group having a carbon number of 1 to 20, preferably a linear or branched alkyl group having a carbon number of 1 to 12 (for example, a methyl group, an ethyl group, a linear or branched propyl group, a linear or branched butyl group, or a linear or branched pentyl group), or a cyclic alkyl group having a carbon number of 3 to 8 (e.g., cyclopentyl, cyclohexyl).

The alkoxy group as R_{1c} to R_{5c} may be linear, branched or cyclic and is, for example, an alkoxy group having a carbon number of 1 to 10, preferably a linear or branched alkoxy group having a carbon number of 1 to 5 (for example, a methoxy group, an ethoxy group, a linear or branched propoxy group, a linear or branched butoxy group, or a linear or branched pentoxy group), or a cyclic alkoxy group having a carbon number of 3 to 8 (e.g., cyclopentyloxy, cyclohexyloxy).

A compound where any one of R_{1c} to R_{5c} is a linear, branched or cyclic alkyl group or a linear, branched or cyclic alkoxy group is preferred, and a compound where the sum of carbon numbers of R_{1c} to R_{5c} is from 2 to 15 is more preferred. By virtue of this construction, the solvent solubility is more enhanced and generation of particles during storage is suppressed.

The alkyl group as Rₓ and R_{y} is the same as the alkyl group of R_{1c} to R_{5c}.

The 2-oxoalkyl group includes a group having >C═O at the 2-position of the alkyl group as R_{1c} to R_{5c}.

The alkoxy group in the alkoxycarbonylmethyl group is the same as the alkoxy group of R_{1c} to R_{5c}.

Examples of the group formed by combining Rₓ and R_{y} include a butylene group and a pentylene group.

Rₓ and R_{y} each is preferably an alkyl group having a carbon number of 4 or more, more preferably 6 or more, still more preferably 8 or more.

In formulae (ZII) and (ZIII), R₂₀₄ to R₂₀₇ each independently represents an aryl group which may have a substituent, or an alkyl group which may have a substituent.

The aryl group of R₂₀₄ to R₂₀₇ is preferably a phenyl group or a naphthyl group, more preferably a phenyl group.

The alkyl group of R₂₀₄ to R₂₀₇ may be linear, branched or cyclic and is preferably a linear or branched alkyl group having a carbon number of 1 to 10 (e.g., methyl, ethyl, propyl, butyl, pentyl), or a cyclic alkyl group having a carbon number of 3 to 10 (e.g., cyclopentyl, cyclohexyl, norbornyl).

Examples of the substituent which R₂₀₄ to R₂₀₇ each may have include an alkyl group (for example, an alkyl group having a carbon number of 1 to 15), an aryl group (for example, an aryl group having a carbon number of 6 to 15), an alkoxy group (for example, an alkoxy group having a carbon number of 1 to 15), a halogen atom, a hydroxyl group, and a phenylthio group.

X⁻ represents a non-nucleophilic anion and is the same as the non-nucleophilic anion of X⁻ in formula (I).

Out of the compounds capable of decomposing upon irradiation with an electron beam or an electromagnetic wave at a wavelength larger than 200 nm to generate an acid, which may be used in combination, preferred compounds further include the compounds represented by the following formulae (ZIV), (ZV) and (ZVI):

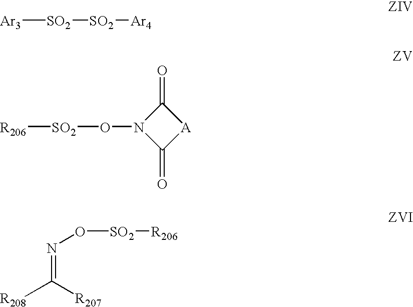

In formulae (ZIV) to (ZVI), Ar₃ and Ar₄ each independently represents a substituted or unsubstituted aryl group.

R₂₀₅₆ represents a substituted or unsubstituted alkyl group or a substituted or unsubstituted aryl group.

R₂₀₇ and R₂₀₈ each represents a substituted or unsubstituted alkyl group, a substituted or unsubstituted aryl group, or an electron-withdrawing group. R₂₀₇ is preferably a substituted or unsubstituted aryl group.

R₂₀₈ is preferably an electron-withdrawing group, more preferably a cyano group or a fluoroalkyl group.

A represents a substituted or unsubstituted alkylene group, a substituted or unsubstituted alkenylene group, or a substituted or unsubstituted arylene group.

Among the compounds capable of decomposing upon irradiation with an electron beam or an electromagnetic wave at a wavelength larger than 200 nm to generate an acid, the compounds represented by formulae (ZI) to (ZIII) are preferred, the compound represented by formula (ZI) is more preferred, and the compounds represented by formulae (ZI-1) to (ZI-3) are most preferred.

Furthermore, a compound that generates an acid represented by the following formulae AC1 to AC3 upon irradiation with an electron beam or an electromagnetic wave at a wavelength larger than 200 nm is preferred:

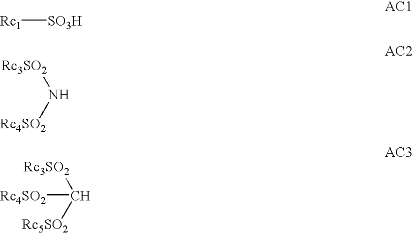

wherein Rc₁ and Rc₃ to Rc₅ are the same as defined above.

That is, a most preferred embodiment of the component (A) is a compound where in the structure of formula (ZI), X⁻ is an anion selected from formulae AN1, AN3 and AN4.

Out of the compounds capable of decomposing upon irradiation with an electron beam or an electromagnetic wave at a wavelength larger than 200 nm to generate an acid, particularly preferred examples are set forth below.

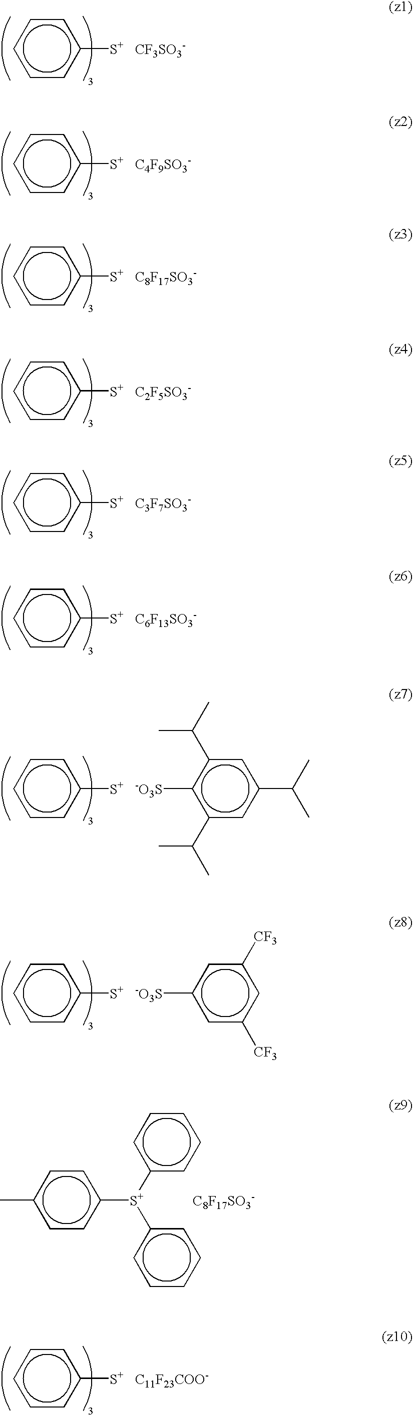

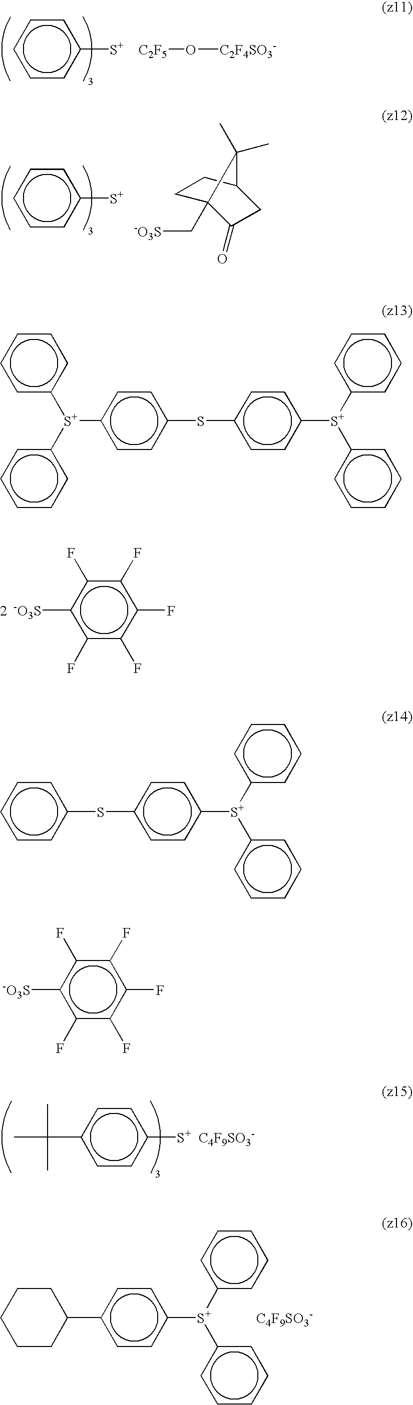

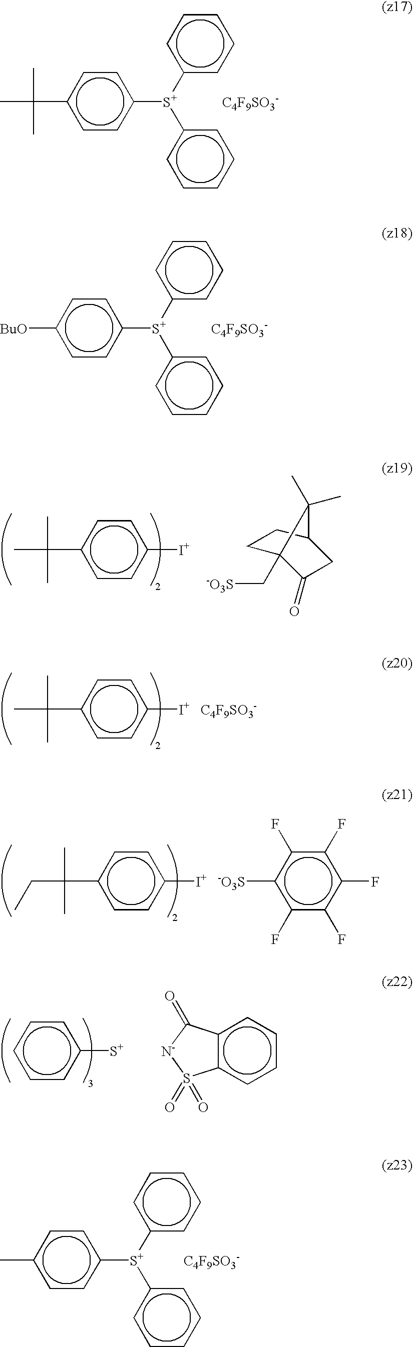

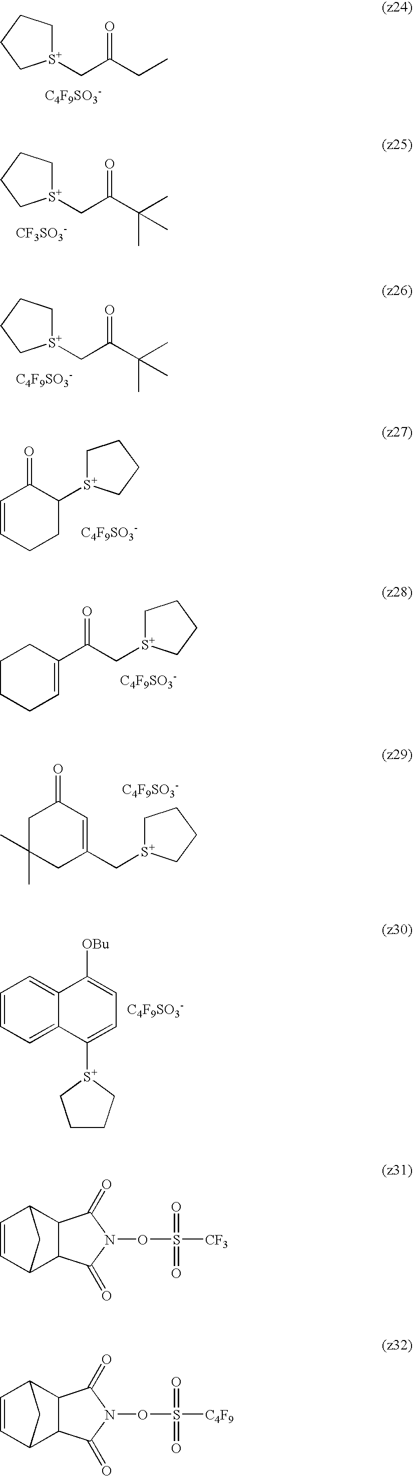

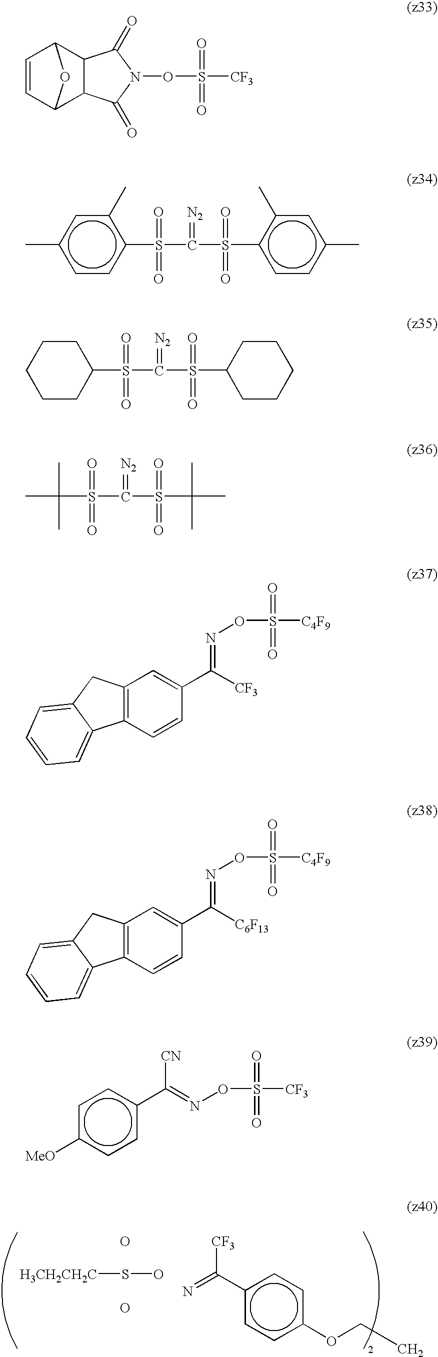

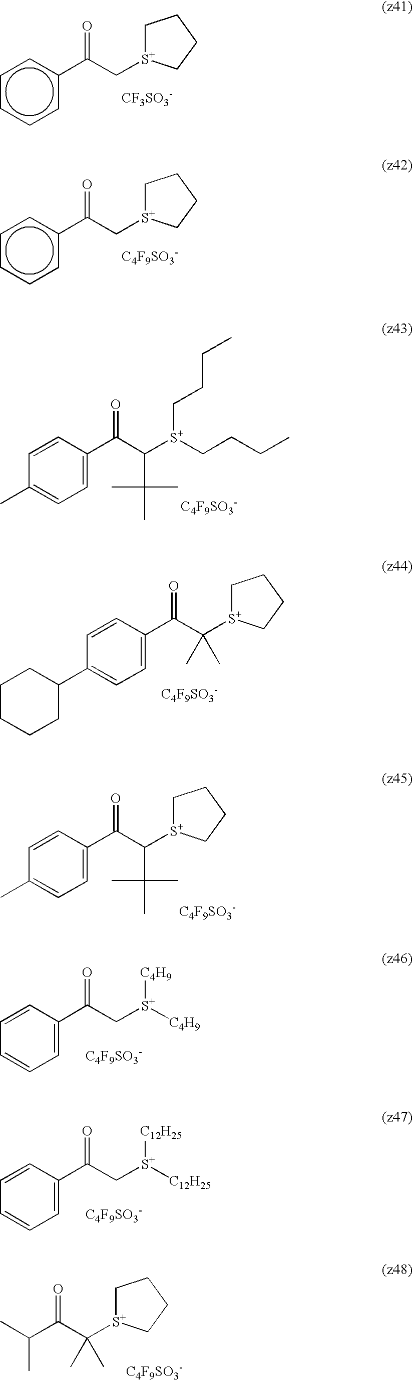

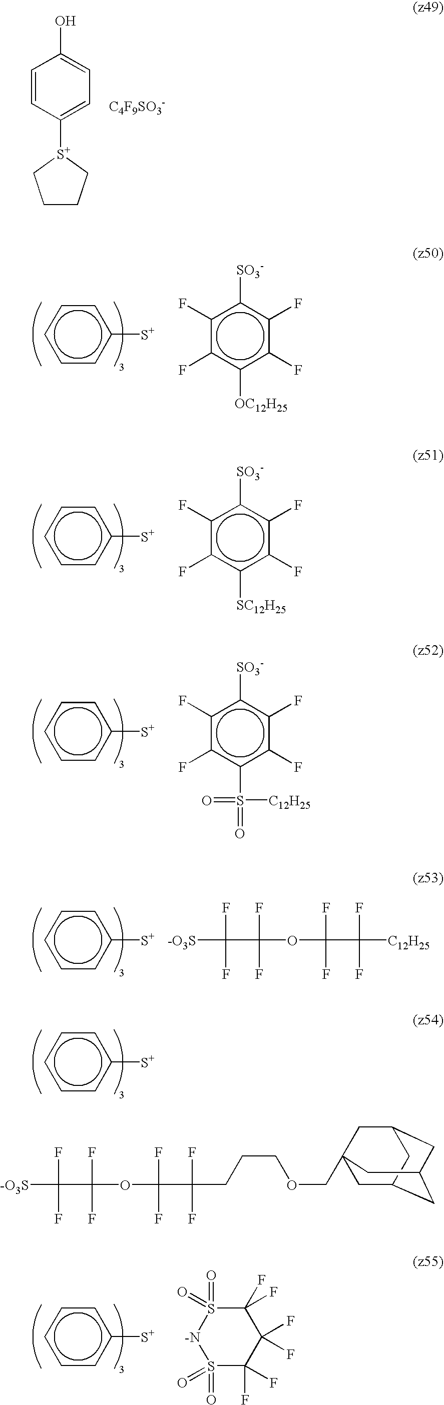

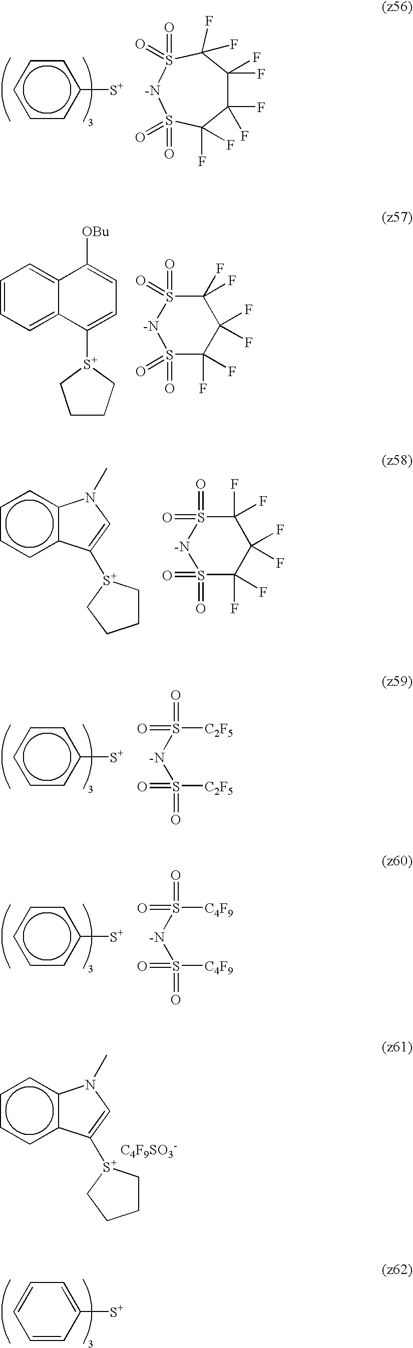

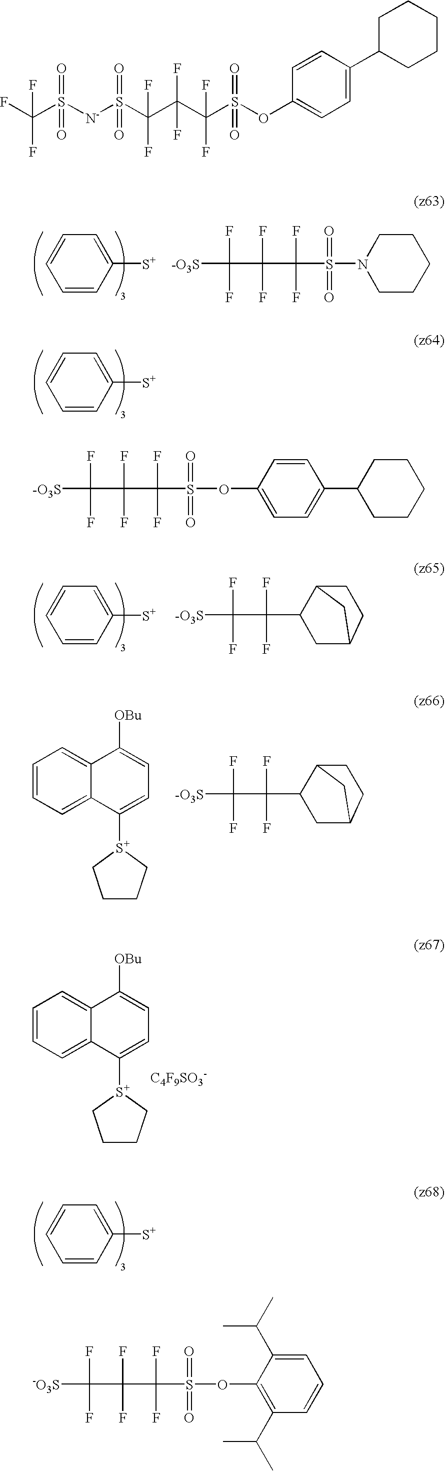

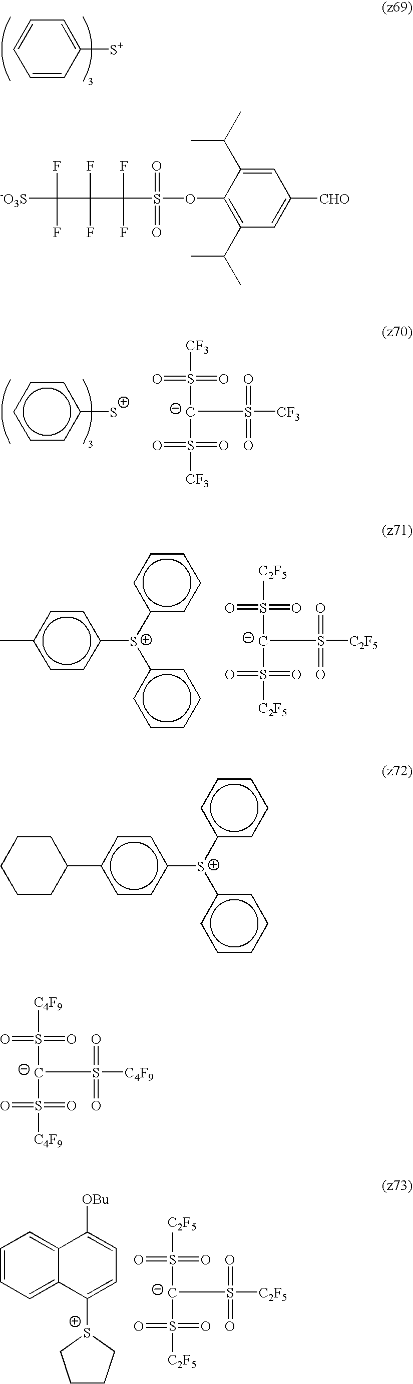

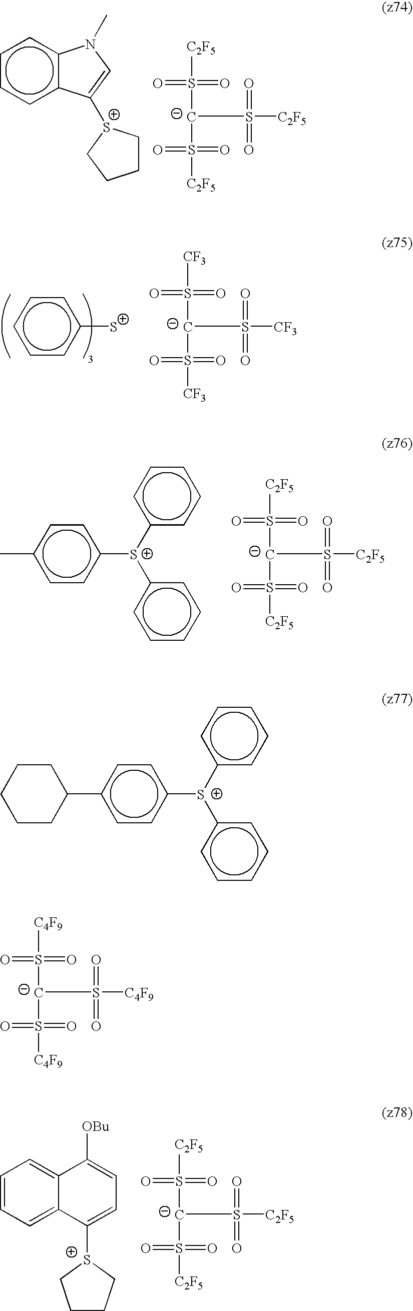

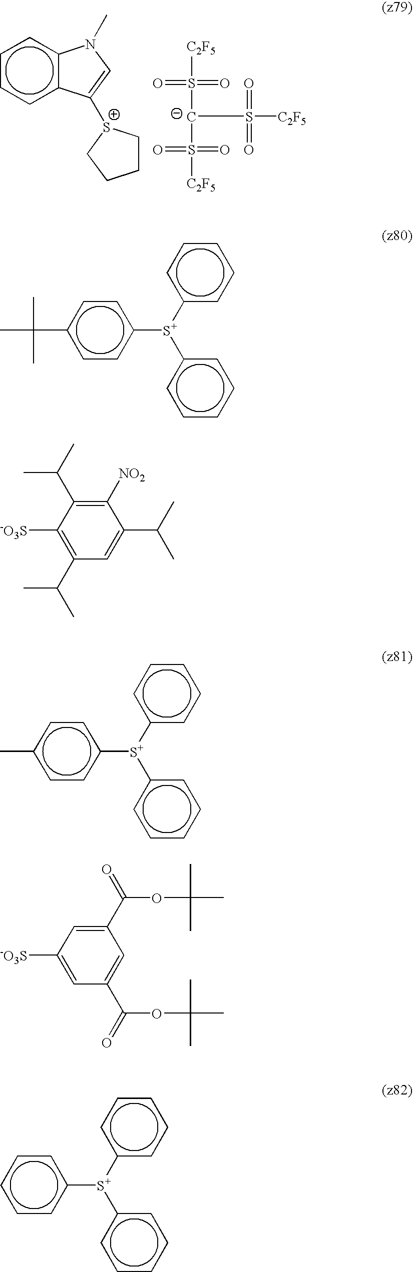

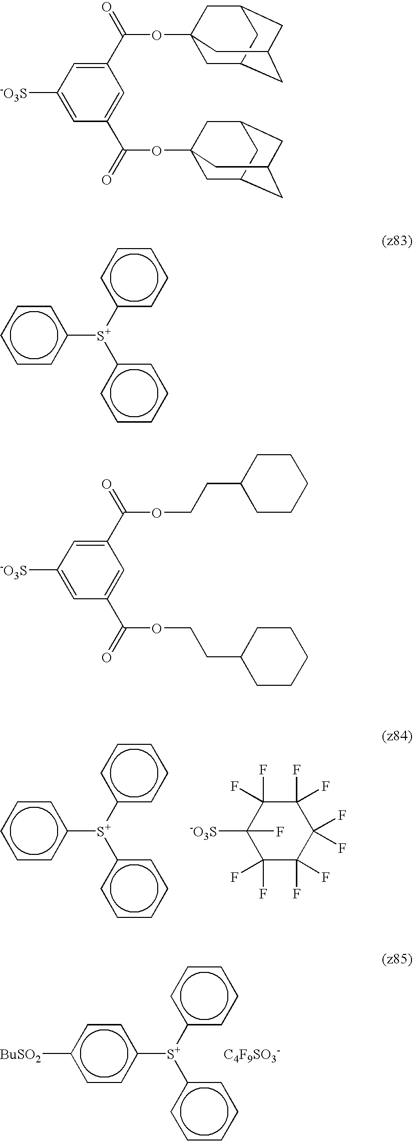

One of these acid generators may be used alone, or two or more kinds thereof may be used in combination. In the case of using two or more kinds in combination, compounds capable of generating two kinds of organic acids differing in the total number of atoms except for hydrogen atom by 2 or more are preferably combined.

The content of the acid generator in the composition is preferably from 0.1 to 20 mass %, more preferably from 0.5 to 10 mass %, still more preferably from 1 to 7 mass %, based on the entire solid content of the composition. (In this specification, mass ratio is equal to weight ratio.)

The oligomer or polymer of the present invention adheres directly to many materials such as compatible polymer, polymer having a normal solvent, metal, particularly texturized metal, silicon or silicon dioxide, particularly etched silicon or silicon dioxide, glass, silicon nitride, aluminum nitride, alumina, gallium arsenide, quartz, and ceramic. However, in the case of requiring high adhesion, a material for enhancing the adhesion may be introduced.

Examples of such an adhesion promoting material include a silane, preferably organosilane, such as trimethoxyvinylsilane, triethoxyvinylsilane, hexamethyldisilazane [(CH₃)₃—Si—NH—Si(CH₃)₃], an aminosilane coupling agent such as γ-aminopropyltriethoxysilane, and a chelate such as aluminum monoethylacetoacetatediisopropylate [(isoC₃H₇O)₂Al(OCOC₂H₅CHCOCH₃)]. In some cases, the adhesion promoter is applied as a 0.01 to 5 wt % solution, excess solution is removed, and then the polyphenylene is applied. In other cases, for example, a chelate of aluminum monoethylacetoacetatediisopropylate may be incorporated onto a substrate by spreading a toluene solution of the chelate on the substrate and then baking the coated substrate at 350° C. for 30 minutes in oxygen to form a very thin (for example, 5 nanometer) adhesion promoting layer of aluminum oxide on the surface. Other means for depositing aluminum oxide are likewise suitable. Also, the adhesion promoter, in an amount of, for example, from 0.05 to 5 wt % based on the weight of the monomer, may be mixed with the monomer before polymerization to negate the need for formation of an additional layer.

The adhesion can be enhanced by a surface treatment such as texturizing (for example, scratching, etching, plasma treatment or buffing) or cleaning (for example, degreasing or sonic cleaning); other treatments (for example, plasma, solvent, SO₃, plasma glow discharge, corona discharge, sodium, wet etching or ozone treatment); sand blasting of the substrate surface; use of an electron beam process, such as 6 MeV fluorine ion, electron at an intensity of 50 to 2,000V, hydrogen cation at 0.2 to 1 MeV, helium cation at 200 KeV to 1 MeV, fluorine or chlorine cation at 0.5 MeV, or neon at 280 KeV; an oxygen enriched flame treatment; or an accelerated argon ion treatment.

As for the application of an oligomerized product of the reaction of 3,3′-(oxydi-1,4-phenylene)bis(2,4,5-triphenylcyclopentadienone) and 1,3,5-tris(phenylethynyl)-benzene, in a more preferred embodiment of the present invention, a silane-based adhesion promoter containing 3-aminopropylsilane dissolved in methanol, which is available as VM-652 from DuPont or AP8000 from The Dow Chemical Company, is first applied to the wafer surface, slowly spread over the entire surface, allowed to stand for 2 seconds, and finally spin-dried at 3,000 rpm for 10 seconds. A solution of the oligomer is dispensed, in 4 mL for a 200-mm wafer, by a high-precision pump/filtration system, Millipore Gen-2, onto the wafer surface while rotating the wafer at 750 rpm. The wafer rotation is accelerated to 2,000 rpm immediately after the dispense of the polymer solution and held at this spin speed for 20 seconds. A continuous stream of mesitylene is applied to the backside of the wafer for 5 seconds during the dispense of the oligomer solution. After spin coating, the film is dried on a hot plate at 70° C. for 20 seconds. After the dry-baking step, the 2 to 5 mm edge bead of the coating is removed by applying a continuous stream of mesitylene from the backside or directly from the top near the edge while rotating the wafer at 2,000 rpm. After the edge bead removal, the coating is baked (ripened under heat) for 40 seconds on a hot plate at 350° C. in a nitrogen stream while irradiating light at a wavelength of 222 nm at an energy of 1 mW/cm² by using a dielectric barrier charge-type excimer lamp manufactured by Ushio Inc., whereby the film is crosslinked.

The oligomer or polymer of the present invention may be applied together with other additives so as to obtain predetermined results. Examples of the additive include a metal-containing compound such as magnetic particle (for example, barium ferrite, iron oxide (if desired, a mixture with cobalt), or other metal-containing particles for use in a magnetic medium, an optical medium or other recording mediums); and an electrically conductive particle such as metal or carbon used for electrically conductive sealant, electrically conductive adhesive, electrically conductive coating, electromagnetic interference (EMI)/radio frequency interference (RFI) shield coating, electrostatic dissipation, and electrical contact. In the case of using these additives, the oligomer or polymer of the invention acts as a binder.

The oligomer or polymer of the present invention may be used as protection against the environment (that is, protection against at least one substance in an environment including conditions of production, storage and use), such as coating for imparting surface passivation to metals, semiconductors, capacitors, inductors, conductors, solar cells, glass, glass fibers, quartz and quartz fibers.

### EXAMPLES

The following Examples are set forth to illustrate the present invention and should not be construed to limit its scope. In Examples, unless otherwise indicated, the parts and % are on the weight basis.

### Example 1

### Production of Cyclopentadienone Compound and Acetylene Compound

Many cyclopentadienone compounds and acetylene compounds were prepared as described below. The structures of these compounds are shown below.

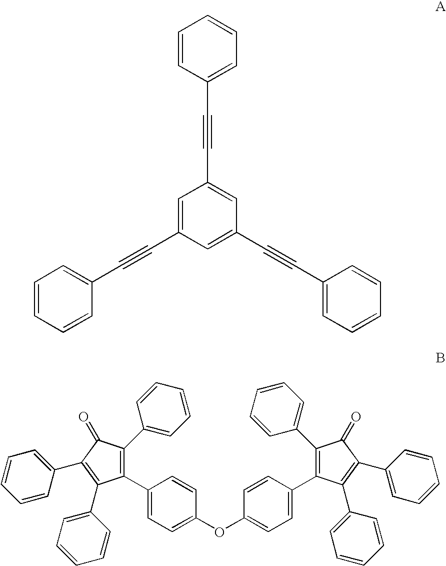

### A. 1,3,5-Tris(phenylethynyl)benzene (Compound A)

Triethylamine (375 g), triphenyl phosphine (4.7865 g), palladium acetate (1.0205 g) and N,N-dimethylformamide (2,000 mL) were charged into a 5 liter-volume three-necked round bottom flask equipped with a thermocouple, an overhead mechanical stirrer, a condenser, an addition funnel and a heating mantle with a temperature controller. This mixture was stirred for 5 minutes to dissolve the catalyst. Subsequently, diethylhydroxylamine (5 g), 1,3,5-tribromobenzene (190 g) and phenylacetylene (67.67 g) were added. The reaction vessel was purged with nitrogen for 15 minutes and then heated to 70° C. while maintaining a nitrogen atmosphere. After heating at 70° C. for 30 minutes, phenylacetylene (135.33 g) was slowly added over about 1 hour, and the temperature was increased to 80° C. Heating was continued for additional 9 hours. The reaction solution was then cooled to room temperature, and water (1 liter) was added to precipitate a crude product. The product was filtered and washed three times with 500 mL of water and then once with 500 mL of cyclohexane. The product was vacuum-dried at 75° C. overnight and through gas chromatography, 226.40 g (yield: 99.1%) of a product with a purity of 97.25% was obtained. The product was dissolved in toluene (1,800 mL) and after filtering through silica gel, the solvent was removed by a rotary evaporator to obtain 214.20 g (yield: 94.2%) of a product purified to a purity of 99.19% by gas chromatography. The residue was then recrystallized from a mixture of toluene (375 mL) and 2-propanol (696 mL). The white crystal was filtered, washed with a mixture of toluene (100 mL) and 2-propanol (400 mL) and vacuum-dried at 75° C. to obtain 1,3,5-tris(phenylethynyl)benzene (190.0 g, yield: 83.91%) purified to a purity of 99.83% by gas chromatography. The product was further recrystallized from toluene/isopropanol, whereby a material containing acceptable levels of organic and ionic impurities was obtained.

B. 3,3′-(Oxydi-1,4-phenylene)bis(2,4,5-triphenylcyclo-pentadienone) (Compound B)

### (a) Preparation of 4,4′-Diphenylacetyldiphenyl Ether

To a slurry of aluminum chloride (97.9 g, 0.734 mol) in methylene dichloride (200 mL), a solution of diphenyl ether (50.0 g, 0.294 mol) and phenylacetyl chloride (102 g, 0.661 mol) in methylene chloride (50 mL) was added over 30 minutes. When the addition was completed, the reaction mixture was allowed to warm to ambient temperature and stirred overnight. The reaction mixture was carefully poured, with stirring, into 1.5 kg of ice/water. Methylene chloride (1,500 mL) was added to dissolve the solid, and the layers are separated. The organic layer was filtered through celite, concentrated, dried and recrystallized from toluene to obtain 110 g (92%) of the titled compound as a light brown prism.

(b) Preparation of 4,4′-bis(phenylglyoxaloyl)diphenyl Ether

An aqueous HBr solution (97 mL of a 48 wt % solution) was added to a slurry of 4,4′-diphenylacetyldiphenyl ether (50.0 g, 0.123 mol) in DMSO (400 mL) and the resulting mixture was heated to 100° C. for 2 hours and then cooled to room temperature. This reaction mixture was partitioned between toluene (500 mL) and water (750 mL). The organic layer was washed with water (3×250 mL), further washed with brine and concentrated to obtain a viscous yellow oil. This oil was solidified when left standing at ambient temperature. Recrystallization from ethanol was performed, as a result, 35.9 g (67%) of a yellow cube was obtained.

### (c) Production of Compound B

Into a nitrogen-purged 5 liter-volume flask equipped with a thermocouple, a reflux condenser with nitrogen inlet, a mechanical stirrer and an addition funnel, 195.4 g (0.4498 mol, 1.0 eq) of 4,4′-bis(phenylglyoxaloyl)diphenyl ether, 193.9 g of diphenylacetone (0.9220 mol, 2.05 eq) and 2.5 L of deoxygenated ethanol were charged. The mixture was refluxed under heating and at this time, a homogeneous solution was obtained. This solution was purged with nitrogen for 30 minutes. To the addition funnel, a solution containing 25.2 g of KOH (0.4498 mol, 1.0 eq), 200 mL of ethanol and 25 mL of water was added. The temperature was reduced to 74° C. and the KOH solution was added over 5 minutes. An exothermic reaction occurred and maintained reflux until three fourths of the solution was added and thereafter, the temperature began to decrease. A dark purple color was observed immediately upon addition of a base, and a solid was observed before the addition was completed. After the completion of addition, the heterogeneous solution was strongly refluxed for 15 minutes to form many solids. This mixture was cooled to 25° C., and 29.7 g of glacial acetic acid (0.4948 mol, 1.1 eq) was added and stirred for 30 minutes. The crude product was isolated by filtration, washed in the funnel with 1 liter of water, 3 liter of ethanol and 2 liter of methanol, and dried in vacuum at 60 to 90° C. for 12 hours to obtain 323 g (92%) crude DPO-CPD which was 94% pure by LC. This crude material was dissolved in HPLC-grade methylene chloride (10 wt %), transferred to a 5 liter-volume flask equipped with a bottom flush valve and a mechanical stirrer, and washed for 10 to 90 minutes, 2 to 7 times with an equivalent amount of low ionic water. Subsequently, a CH₂Cl₂ solution was flowed through a 5-cm column containing 75 g of silica gel in CH₂Cl₂. The column was washed with 1 liter of CH₂Cl₂ and at this time, the filtrate was substantially clear. This solution was evaporated to dryness, redissolved in THF and evaporated again to remove the bulk of residual methylene chloride. The powder obtained was transferred to a 5 liter-volume flask equipped with an addition funnel and a Friedrichs reflux condenser, and dissolved (from 0.07 to 0.12 g/mL) in deoxygenated HPLC THF. Subsequently, 1 liter of THF was further added and a nitrogen purge tube was inserted into the solution. The solution was purged with nitrogen for 3 hours and after the THF was concentrated at 45 to 50° C., the residual methylene chloride was removed by distillation. A distillation head was attached and from 700 mL to 1 liter of THF was removed. The solution was slowly cooled to room temperature over several hours and then cooled to 10° C. or less in an ice bath, during which crystallization occurred. The crystal was filtered using a 5-mm PTFE filter. This crystal was washed with 1 liter of methanol and dried overnight at 80 to 90° C. in vacuum to obtain DPO-CPD having an LC purity of 99% at a yield of 70 to 85%. mp: 270° C.

### Example 2

### Production of Oligomer Solution from 3,3′-(Oxydi-1,4-phenylene)bis(2,4,5-triphenylcyclopentadienone) (Compound B) and 1,3,5-tris(phenylethynyl)benzene (Compound A):

To a Pyrex-made 1 liter-volume three-necked round bottom flask subjected to rinsing with deionized water and HPLC-grade acetone and drying, low ionic 3,3′-(oxydi-1,4-phenylene)bis(2,4,5-triphenylcyclopentadienone) (100.0 g, 0.128 mol), low ionic 1,3,5-tris(phenylethynyl)benzene (48.3 g, 0.128 mol) and electronic grade N-methyl-pyrrolidinone (346 g) were added. The flask was connected to a nitrogen/vacuum inlet. The magnetically stirred solution was degassed by applying vacuum and refilling with nitrogen five times. Subsequently, nitrogen gas was flowed through the headspace of the flask and discharged through a mineral oil bubbler. The solution was then heated to an internal temperature of 200° C. After heating for 8.5 hours, the solution was cooled and transferred into a tetrafluoroethylene-made bottle. Analysis of this final solution by gel permeation chromatography indicated Mₙ=1498 and M_{w}=2746 based on a polystyrene standard. Also, analysis of the final solution by reverse phase chromatography indicated that the level of residual 3,3′-(oxydi-1,4-phenylene)bis(2,4,5-triphenylcyclopentadienone) was 1.8 wt %. Furthermore, analysis of the final solution by neutron activation indicated that the sodium level was 52 ppb, the potassium level was 190 ppb, the palladium level was 90 ppb, the bromine level was 2.4 ppb, the iodine level was 0.6 ppb, and the chlorine level was 2.4 ppb.

### Comparative Example 1

### Coating and Curing of Oligomer Solution from Example 2

A silane-based adhesion promoter, AP8000, available from The Dow Chemical Company was applied, in 3 mL for a 200-mm wafer, to the surface of a wafer, slowly spread over the entire surface, allowed to stand for 2 seconds, and finally spun at 3,000 rpm for 10 seconds. The polyphenylene oligomer solution produced in Example 2 was applied, in 3 mL for a 200-mm wafer, by a precision pump/filtration system, and Millipore Gen-2 was spun at 750 rpm onto the adhesion promoter-coated wafer surface. The wafer rotation was immediately accelerated to 2,000 rpm to apply the oligomer solution and held at this spin speed for 20 seconds. A continuous stream of mesitylene was applied to the backside of the wafer for 5 seconds during the application of the oligomer solution. After spin-coating the wafer with the oligomer, the film was dried on a hot plate at 70° C. for 20 seconds. After the drying, the 2 to 5 mm edge bead of the coating was removed by applying a continuous stream of mesitylene from the backside or directly from the top while spinning the wafer at 2,000 rpm. After the edge removal, the oligomer was further polymerized on a hot plate at 325° C. for 90 seconds in a nitrogen atmosphere. The coating was then baked (ripened under heat) for 40 seconds on a hot plate at 350° C. in a nitrogen stream while irradiating light at a wavelength of 222 nm at an energy of 1 mW/cm² by using a dielectric barrier charge-type excimer lamp manufactured by Ushio Inc. The dielectric constant of the thus-obtained insulating film was calculated from the capacitance value measured at 1 MHz by using a mercury prober manufactured by Four Dimensions, Inc. and an LCR meter, HP4285A, manufactured by Yokogawa-Hewlett-Packard, Ltd. and found to be 2.70. Also, the film had a glass transition temperature higher than 450° C. as measured by dynamic mechanical analysis. Furthermore, the mechanical strength was measured using Nanoindentor SA2 manufactured by MTS and found to be 4.8 GPa.

### Example 3

### Coating and Curing 2 of Oligomer Solution from Example 2

A silane-based adhesion promoter, AP8000, available from The Dow Chemical Company was applied, in 3 mL for a 200-mm wafer, to the surface of a wafer, slowly spread over the entire surface, allowed to stand for 2 seconds, and finally spun at 3,000 rpm for 10 seconds. A solution prepared by adding, to the polyphenylene oligomer solution produced in Example 2, a photoacid generator and Compound z3 in an amount of 0.3 wt % based on the weight of the solution was applied, in 3 mL for a 200-mm wafer, by a precision pump/filtration system, and Millipore Gen-2 was spun at 750 rpm onto the adhesion promoter-coated wafer surface. The wafer rotation was immediately accelerated to 2,000 rpm to apply the oligomer solution and held at this spin speed for 20 seconds. A continuous stream of mesitylene was applied to the backside of the wafer for 5 seconds during the application of the oligomer solution. After spin-coating the wafer with the oligomer, the film was dried on a hot plate at 70° C. for 20 seconds. After the drying, the 2 to 5 mm edge of the coating was removed by applying a continuous stream of mesitylene from the backside or directly from the top while spinning the wafer at 2,000 rpm. After the edge removal, the oligomer was further polymerized on a hot plate at 325° C. for 90 seconds in a nitrogen atmosphere. The coating was then baked (ripened under heat) for 40 seconds on a hot plate at 350° C. in a nitrogen stream while irradiating light at a wavelength of 222 nm at an energy of 1 mW/cm² by using a dielectric barrier charge-type excimer lamp manufactured by Ushio Inc. The dielectric constant of the thus-obtained insulating film was calculated from the capacitance value measured at 1 MHz by using a mercury prober manufactured by Four Dimensions, Inc. and an LCR meter, HP4285A, manufactured by Yokogawa-Hewlett-Packard, Ltd. and found to be 2.72. Also, the film had a glass transition temperature higher than 450° C. as measured by dynamic mechanical analysis. Furthermore, the mechanical strength was measured using Nanoindentor SA2 manufactured by MTS and found to be 6.2 GPa. Thus, the mechanical strength was elevated by the addition of a photoacid generator.

By using the film-forming composition of the present invention, gap fill and planarization of the patterned surface by the reaction product are enabled and when cured under the catalytic action of an acid produced from a photoacid generator, an insulating film having high thermal stability, a high glass transition temperature, high mechanical strength and a low dielectric constant can be formed. Furthermore, it becomes possible to use the film-forming composition of the present invention as an integrated dielectric layer in an integrated circuit.

The entire disclosure of each and every foreign patent application from which the benefit of foreign priority has been claimed in the present application is incorporated herein by reference, as if fully set forth.

What is claimed is:

1. A film-forming composition, comprising:
a photoacid generator; and
a crosslinked or crosslinkable polyphenylene that is a product of a Diels-Alder reaction between at least one kind of a compound having two or more diene functional groups and at least one kind of a compound having two or more dienophile functional groups, in which at least one of the compounds has three functional groups as the functional group.

2. The film-forming composition according to claim 1,
wherein the dienophile functional group is an acetylene group.

3. The film-forming composition according to claim 2,
wherein the polyphenylene is an oligomer, an uncured polymer or a cured polymer,
the diene functional group is a cyclopentadienone group, and
a ratio of cyclopentadienone group:acetylene group is from 1:1 to 1:3.

4. The film-forming composition according to claim 1, further comprising:
an adhesion promoter.

5. The film-forming composition according to claim 1,
wherein the polyphenylene is an oligomer, an uncured polymer or a cured polymer, which is produced by reacting a biscyclopentadienone (a) represented by the following formula and an aromatic acetylene (b) containing three or more acetylene groups represented by the following formula:
(a) biscyclopentadienone 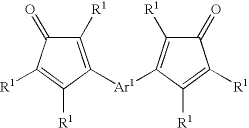
(b) polyfunctional acetylene 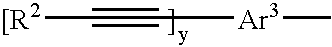
wherein R¹ and R² each independently represents H or an unsubstituted or inertly-substituted aromatic moiety;
Ar¹ and Ar³ each independently represents an unsubstituted aromatic moiety or inertly-substituted aromatic moiety; and
y represents an integer of 3 or more.

6. The film-forming composition according to claim 1,
wherein the photoacid generator generates an acid upon irradiation with an electron beam or an electromagnetic wave at a wavelength larger than 200 nm.

7. The film-forming composition according to claim 6,
wherein the photoacid generator is a compound represented by any one of formulae (ZI), (ZII) and (ZIII): 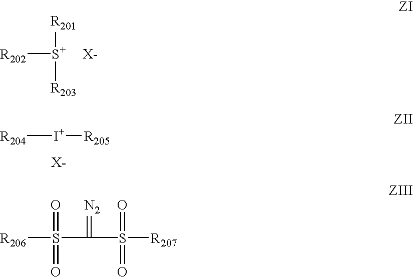
wherein,
in formula (ZI), R₂₀₁, R₂₀₂ and R₂₀₃ each independently represents an organic group; and X⁻ represents a non-nucleophilic anion, and
in formulae (ZII) and (ZIII), R₂₀₄ to R₂₀₇ each independently represents an aryl group which may have a substituent or an alkyl group which may have a substituent; and X⁻ represents a non-nucleophilic anion.

8. A method for producing a film, comprising:
applying the film-forming composition of claim 1 to a substrate; and
irradiating the applied composition with an electron beam or an electromagnetic wave at a wavelength larger than 200 nm.
